(19) United States
(12) Patent Application Publication
(10) Pub. No.: US 2025/0110606 A1
(43) Pub. Date: Apr. 3, 2025

(54) SUGGESTING CONTENT BASED ON PHYSICAL OBJECTS IN AN ENVIRONMENT

(71) Applicant: Apple Inc., Cupertino, CA (US)

(72) Inventors: Thomas G. SALTER, San Francisco, CA (US); Christopher I. WORD, San Francisco, CA (US); Jeffrey S. NORRIS, Saratoga, CA (US); Paulo R. JANSEN DOS REIS, San Jose, CA (US); Evan JONES, Kirkland, WA (US); Peter BURGNER, Venice, CA (US); Thomas J. MOORE, Northglenn, CO (US); Christopher D. FU, Fremont, CA (US); Michael J. ROCKWELL, Palo Alto, CA (US); Tigran KHACHATRYAN, North Hills, CA (US); Guilherme KLINK, Cupertino, CA (US)

(21) Appl. No.: 18/892,264

(22) Filed: Sep. 20, 2024

Related U.S. Application Data
(60) Provisional application No. 63/556,592, filed on Feb. 22, 2024.
(60) Provisional application No. 63/586,969, filed on Sep. 29, 2023.

(51) Int. Cl. G06F 3/04815; G06F 3/01; G06F 40/174; G06T 11/00; G06V 20/20

(52) U.S. Cl. CPC G06F 3/04815; G06F 3/013; G06F 40/174; G06T 11/00; G06V 20/20; G06T 2200/24

(57) ABSTRACT

Some examples of the disclosure are directed to systems and methods for presenting one or more user interface elements including suggested content based on detection of physical objects in a computer-generated environment. In some examples, the electronic device captures one or more images of a physical environment, including a first object (e.g., a fillable form). In some examples, in accordance with detecting, in the one or more images, a first region (e.g., a first fillable field) of the first object and that one or more first criteria are satisfied, the electronic device displays a first user interface element including first suggested text, wherein the first user interface element is displayed at a first location based on the first region.

### CROSS-REFERENCE TO RELATED APPLICATIONS

This application claims the benefit of U.S. Provisional Application No. 63/556,592, filed Feb. 22, 2024, and U.S. Provisional Application No. 63/586,969, filed Sep. 29, 2023, the contents of which are herein incorporated by reference in their entireties for all purposes.

### FIELD OF THE DISCLOSURE

This relates generally to systems and methods of presenting user interface elements including suggested text based on detection of one or more regions of a physical object in a three-dimensional environment.

### BACKGROUND OF THE DISCLOSURE

Some computer graphical environments provide two-dimensional and/or three-dimensional environments where at least some objects displayed for a user's viewing are virtual and generated by a computer. In some examples, a physical environment (e.g., including one or more physical objects) is presented, optionally along with one or more virtual objects, in a three-dimensional environment.

### SUMMARY OF THE DISCLOSURE

Some examples of the disclosure are directed to systems and methods for presenting one or more user interface elements including suggested content based on detection of physical objects in a computer-generated environment. In some examples, a method is performed at an electronic device in communication with one or more displays, one or more input devices, and one or more cameras. In some examples, the electronic device captures, via the one or more cameras, one or more images of a physical environment, including a first object (e.g., a form with fillable fields). In some examples, in accordance with detecting, in the one or more images, a first region of the first object (e.g., a first fillable field) and that one or more first criteria are satisfied, the electronic device displays, via the one or more displays, a first user interface element including first suggested text in a computer-generated environment, wherein the first user interface element is displayed at a first location based on the first region. In some examples, in accordance with detecting, in the one or more images, a second region (e.g., a second fillable field), different from the first region, of the first object and that one or more second criteria are satisfied, the electronic device displays, via the one or more displays, a second user interface element including second suggested text in the computer-generated environment, wherein the second user interface element is displayed at a second location, different from the first location, based on the second region.

In some examples, satisfaction of the one or more first criteria and the one or more second criteria are based on whether user intent to interact with the first object is detected via the one or more input devices when detecting the first region or the second region of the first object. In some examples, the one or more first criteria include a criterion that is satisfied when the electronic device detects gaze of the user directed to the first region when the first region of the first object is detected and the one or more second criteria include a criterion that is satisfied when the electronic device detects the gaze of the user directed to the second region when the second region of the first object is detected. In some examples, the one or more first criteria include a criterion that is satisfied when the electronic device detects a gesture performed by a finger or hand of the user directed to the first region (e.g., pointing to a fillable field using a finger) when the first region of the first object is detected and the one or more second criteria include a criterion that is satisfied when the electronic device detects a gesture performed by a hand of the user directed to the second region when the second region of the first object is detected. In some examples, the one or more first criteria include a criterion that is satisfied when the electronic device detects a second object associated with a hand of the user directed to the first region when the first region of the first object is detected and the one or more second criteria include a criterion that is satisfied when the electronic device detects a second object associated with the hand of the user directed to the second region when the second region of the first object is detected.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIGS. 3A-3M illustrate examples of an electronic device displaying user interface elements including suggested text based on detection of one or more regions of a physical object according to some examples of the disclosure.

FIGS. 4A-4C illustrate examples of an electronic device displaying user interface elements including suggested text based on detection of one or more regions of a physical object according to some examples of the disclosure.

FIG. 5 is a flow diagram illustrating an example process for displaying a user interface element including suggested text based on detection of a region of a physical object according to some examples of the disclosure.

### DETAILED DESCRIPTION

Some examples of the disclosure are directed to systems and methods for presenting one or more user interface elements including suggested content based on detection of physical objects in a computer-generated environment. In some examples, a method is performed at an electronic device in communication with one or more displays, one or more input devices, and one or more cameras. In some examples, the electronic device captures, via the one or more cameras, one or more images of a physical environment, including a first object (e.g., a form with fillable fields). In some examples, in accordance with detecting, in the one or more images, a first region of the first object (e.g., a first fillable field) and that one or more first criteria are satisfied, the electronic device displays, via the one or more displays, a first user interface element including first suggested text in a computer-generated environment, wherein the first user interface element is displayed at a first location based on the first region. In some examples, in accordance with detecting, in the one or more images, a second region (e.g., a second fillable field), different from the first region, of the first object and that one or more second criteria are satisfied, the electronic device displays, via the one or more displays, a second user interface element including second suggested text in the computer-generated environment, wherein the second user interface element is displayed at a second location, different from the first location, based on the second region.

In some examples, satisfaction of the one or more first criteria and the one or more second criteria are based on whether user intent to interact with the first object is detected via the one or more input devices when detecting the first region or the second region of the first object. In some examples, the one or more first criteria include a criterion that is satisfied when the electronic device detects gaze of the user directed to the first region when the first region of the first object is detected and the one or more second criteria include a criterion that is satisfied when the electronic device detects the gaze of the user directed to the second region when the second region of the first object is detected. In some examples, the one or more first criteria include a criterion that is satisfied when the electronic device detects a gesture performed by a finger or hand of the user directed to the first region (e.g., pointing to a fillable field using a finger) when the first region of the first object is detected and the one or more second criteria include a criterion that is satisfied when the electronic device detects a gesture performed by a hand of the user directed to the second region when the second region of the first object is detected. In some examples, the one or more first criteria include a criterion that is satisfied when the electronic device detects a second object associated with a hand of the user directed to the first region when the first region of the first object is detected and the one or more second criteria include a criterion that is satisfied when the electronic device detects a second object associated with the hand of the user directed to the second region when the second region of the first object is detected.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

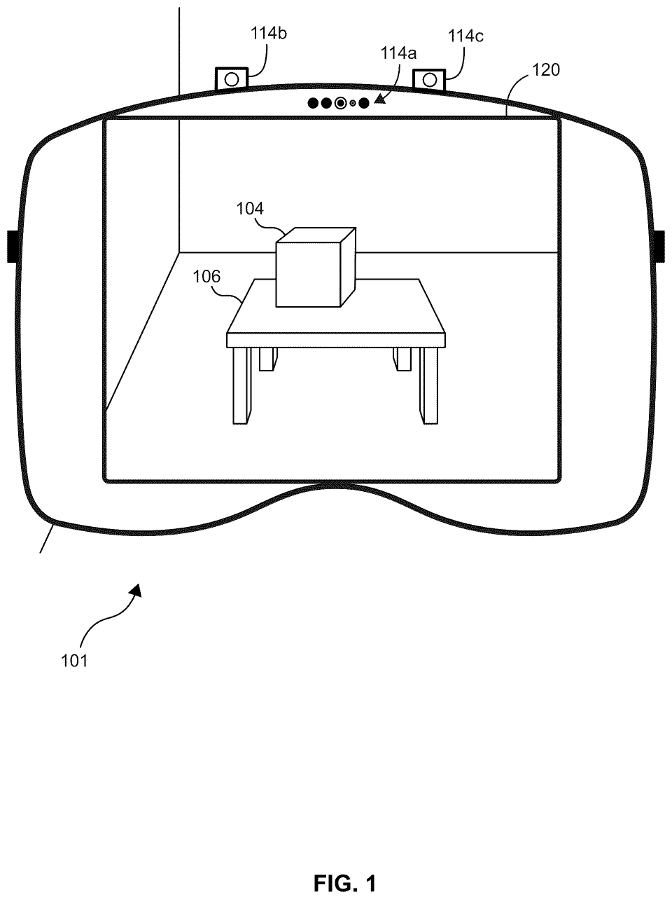

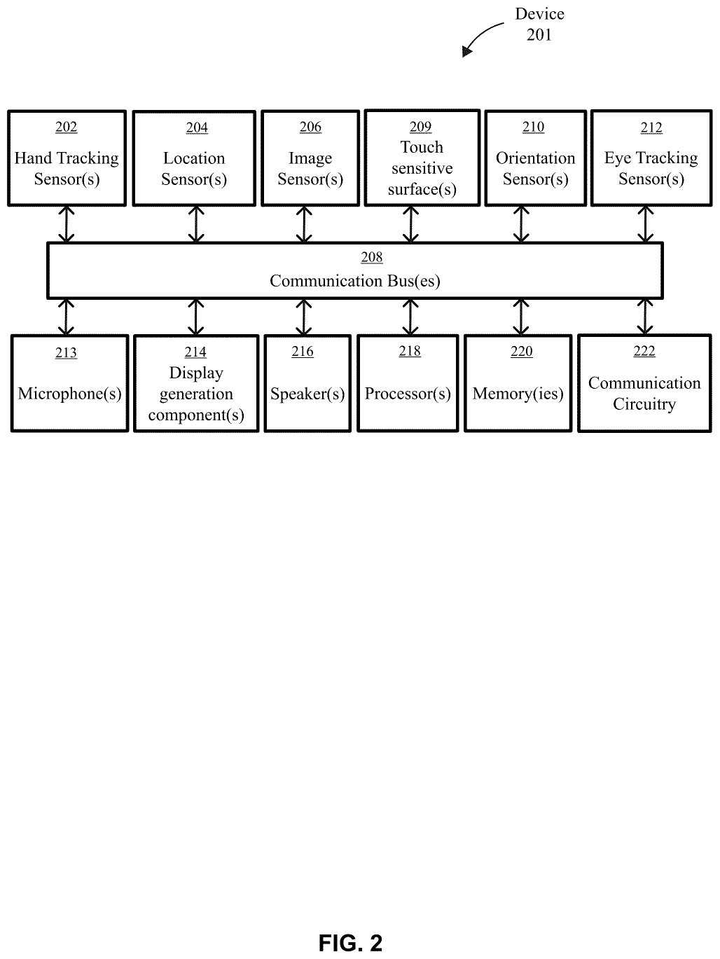

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., leg, torso, head, or hands of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards interactions with one or more virtual objects that are displayed in a three-dimensional environment presented at an electronic device (e.g., corresponding to electronic device 201). Particularly, in some examples, while a physical environment is visible in the three-dimensional environment, the electronic device visually detects one or more regions of a physical object in the physical environment, such as one or more fillable fields of a document (e.g., a physical document or a digital document displayed on a second electronic device). In some examples, in response to visually detecting the one or more regions of the physical object, the electronic device displays one or more user interface elements including suggested text in the three-dimensional environment, where the suggested text is generated based on one or more characteristics of the one or more regions of the physical object.

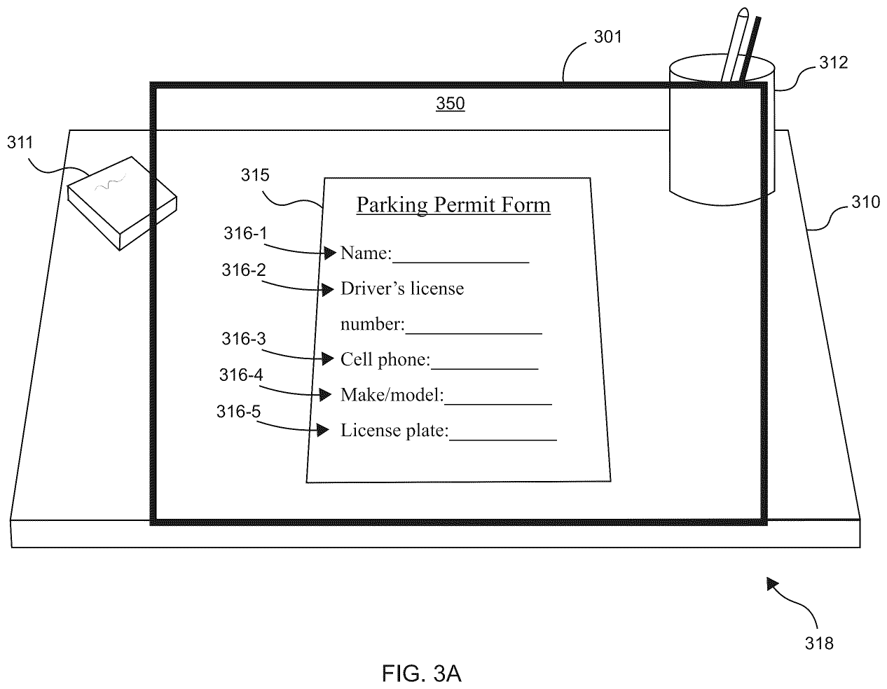

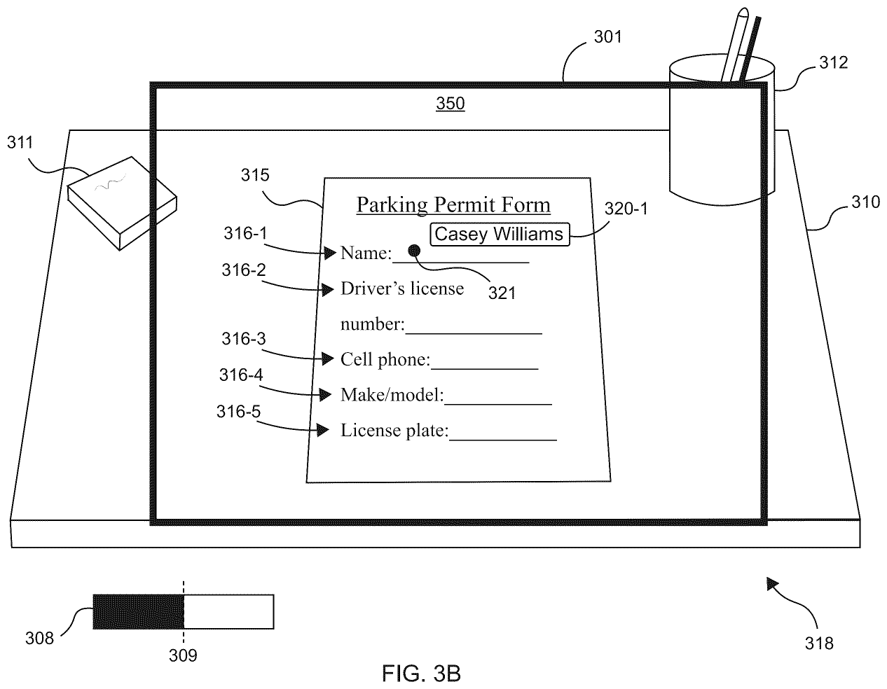

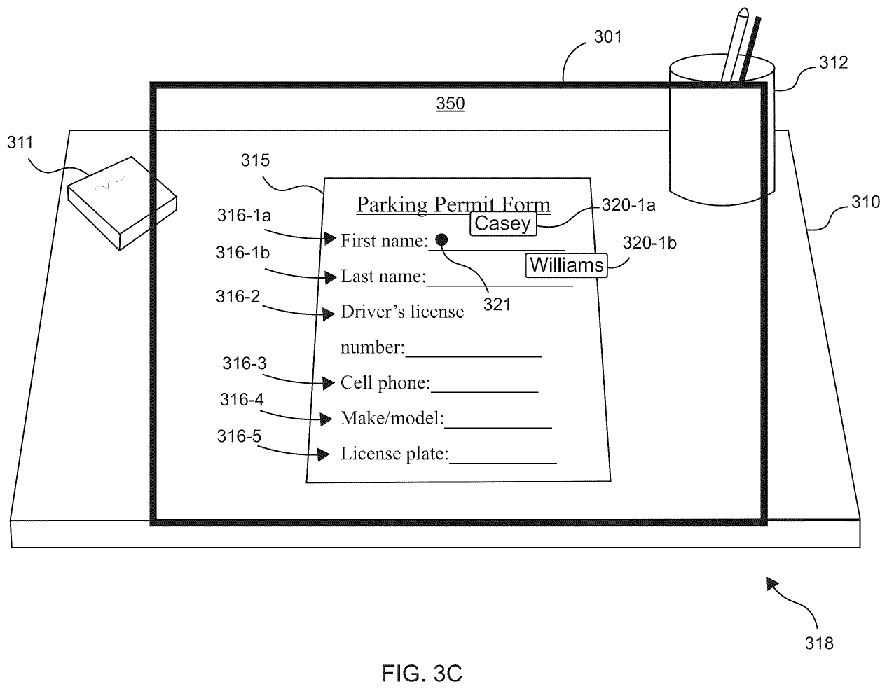

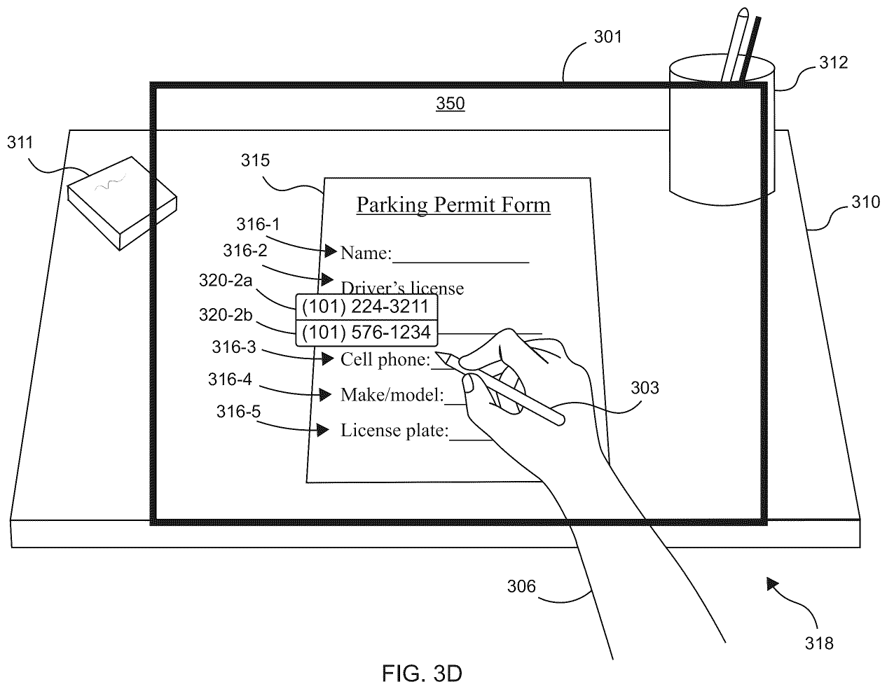

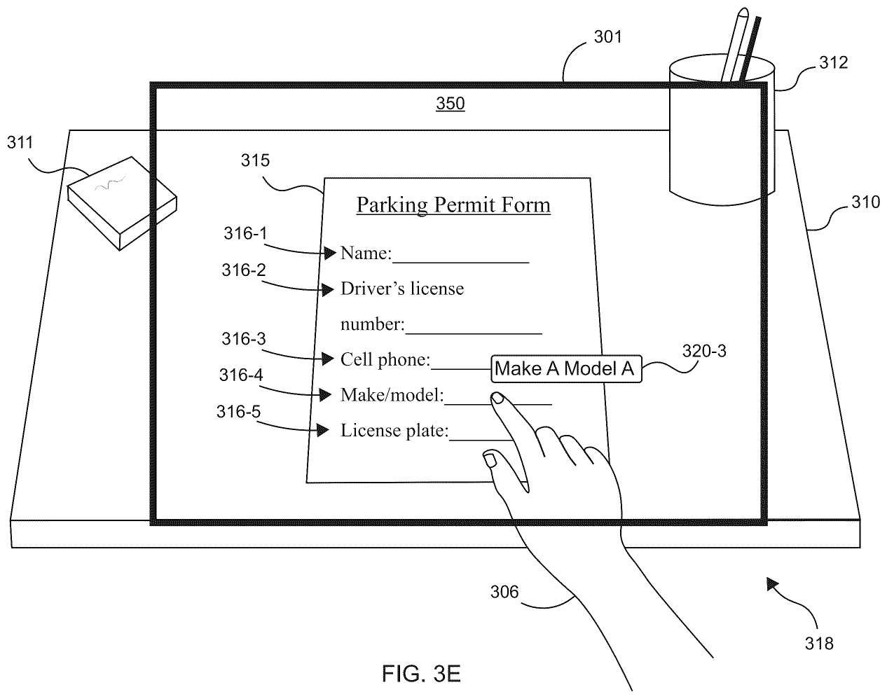

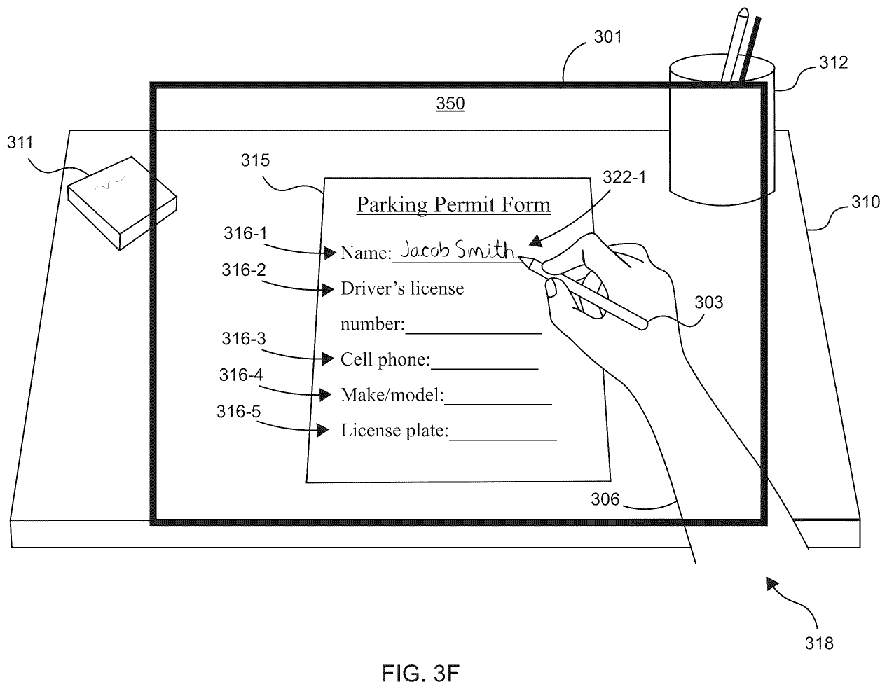

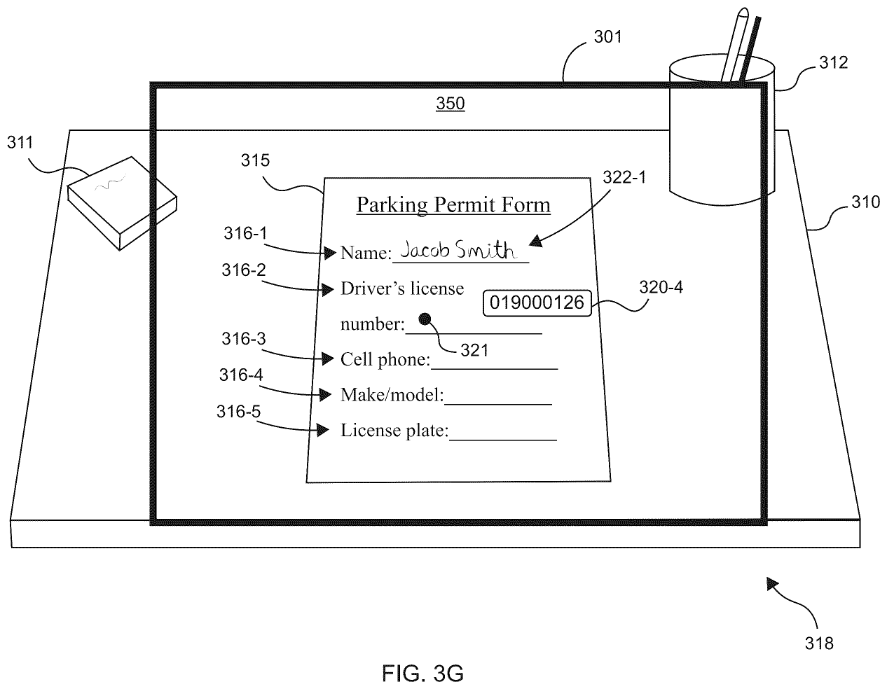

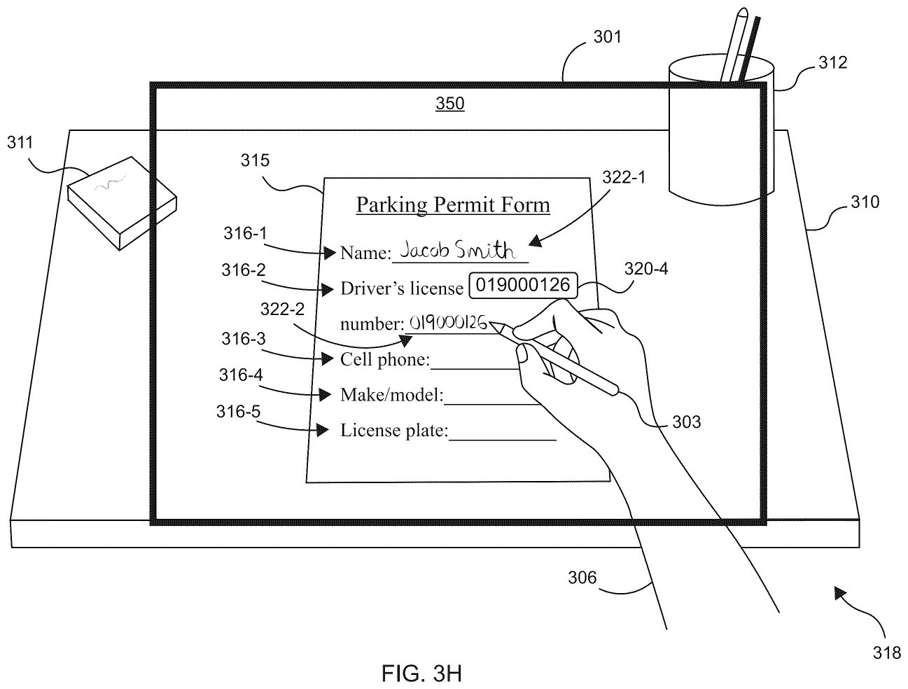

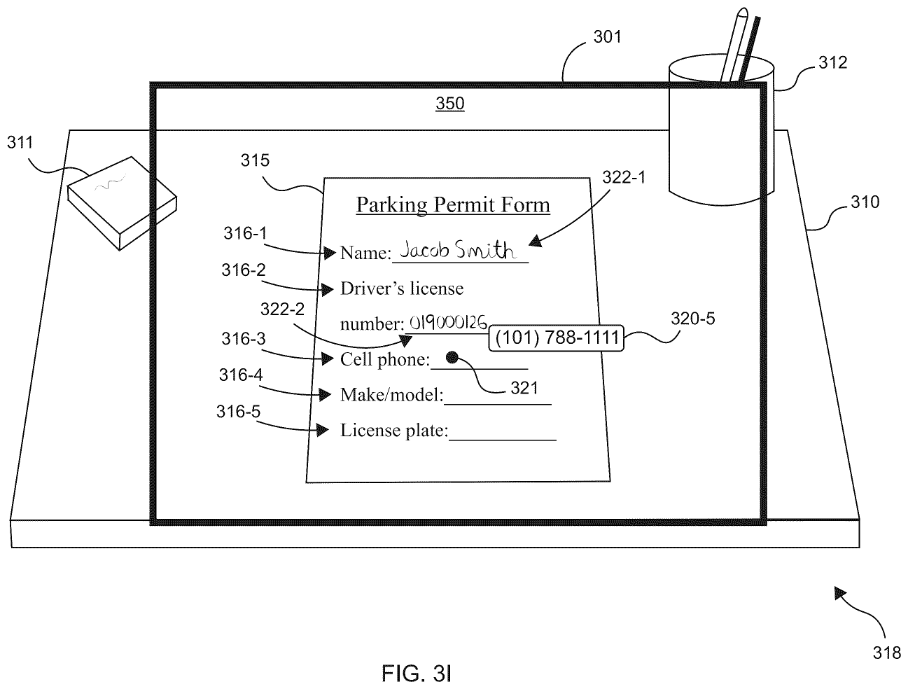

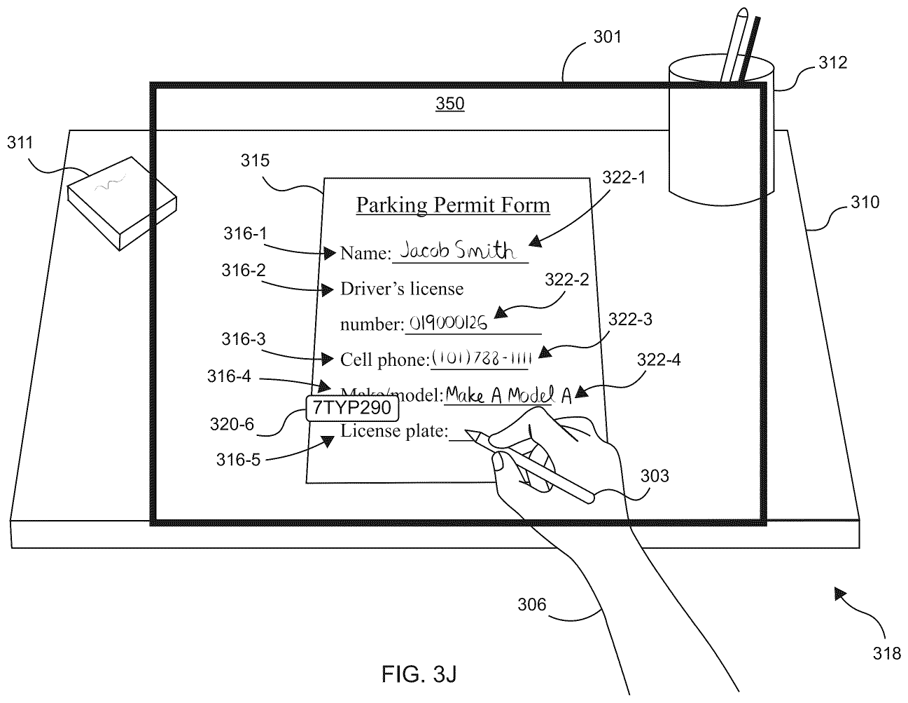

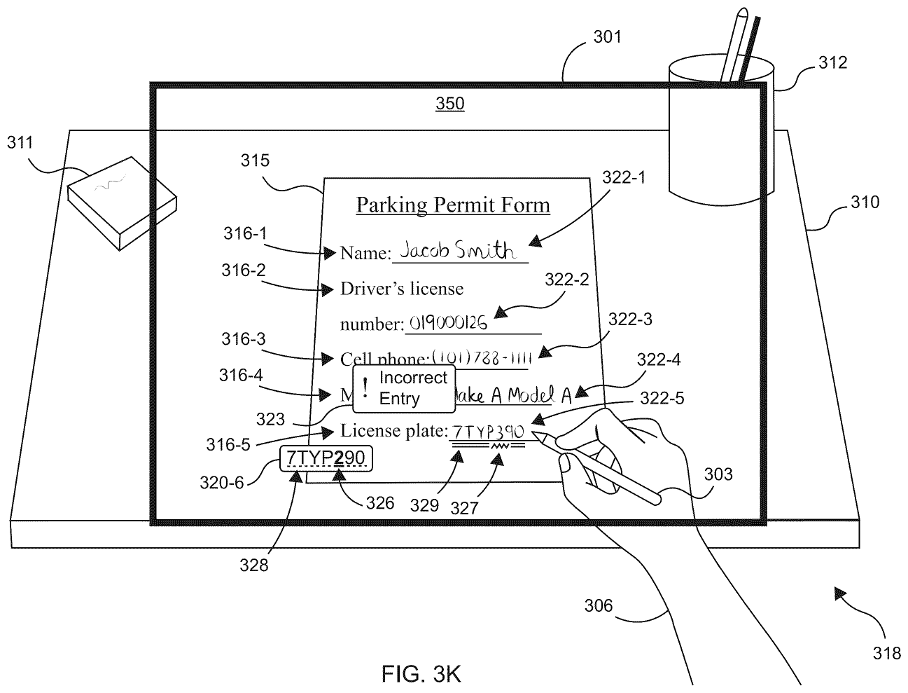

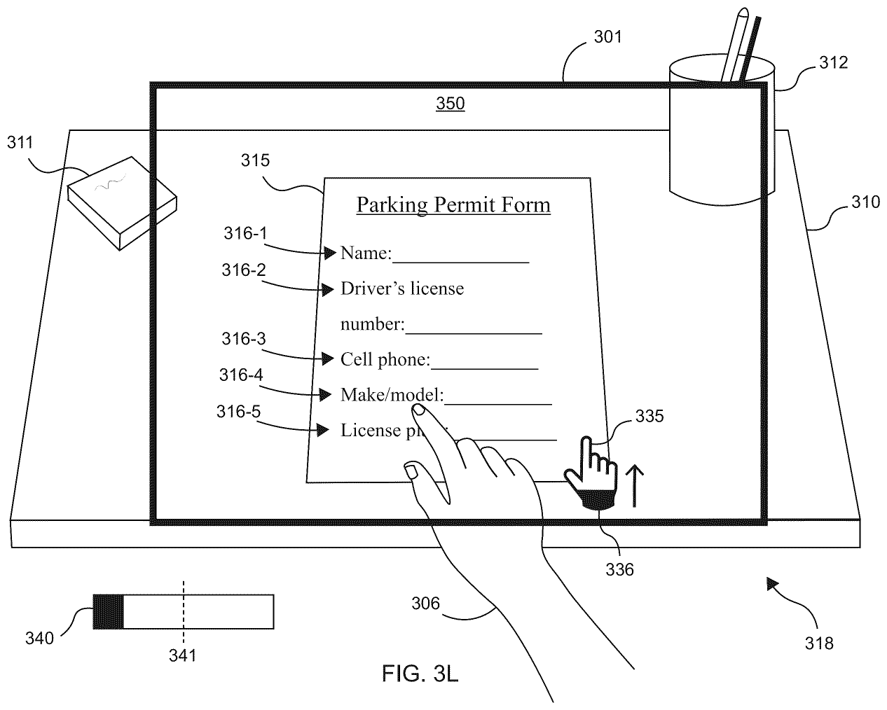

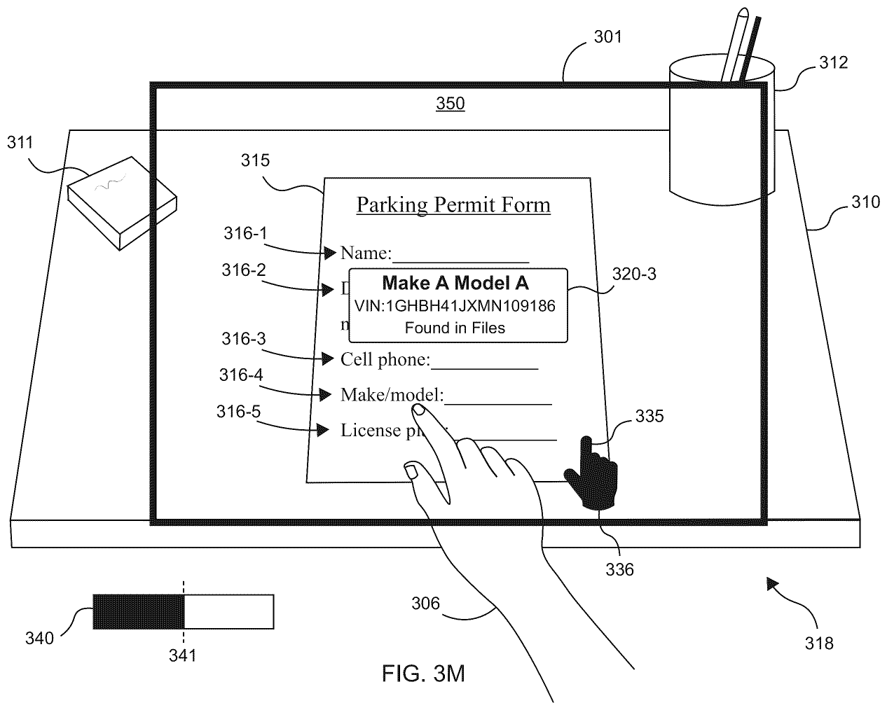

FIGS. 3A-3M illustrate examples of an electronic device displaying user interface elements including suggested text based on detection of one or more regions of a physical object according to some examples of the disclosure. The electronic device 301 may be similar to electronic device 101 or 201 discussed above, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, or displays formed as lenses designed to be placed on a person's eyes (e.g., similar to contact lenses). In the examples of FIGS. 3A-3M, a user is optionally wearing the electronic device 301, such that three-dimensional environment 350 (e.g., a computer-generated environment) can be defined by X, Y and Z axes as viewed from a perspective of the electronic device (e.g., a viewpoint associated with the user of the electronic device 301). Accordingly, as used herein, the electronic device 301 is configured to be movable with six degrees of freedom based on the movement of the user (e.g., the head of the user), such that the electronic device 301 may be moved in the roll direction, the pitch direction, and/or the yaw direction.

As shown in FIG. 3A, the electronic device 301 may be positioned in a physical environment (e.g., an indoors environment) that includes a plurality of real-world objects. For example, in FIG. 3A, the electronic device 301 may be positioned adjacent to and/or above table 310 in physical environment 318 (e.g., corresponding to table 106 in FIG. 1). Accordingly, in some examples, the three-dimensional environment 350 presented using the electronic device 301 optionally includes captured portions of the physical environment 318 surrounding the electronic device 301, such as one or more representations of the table 310 in the field of view of the three-dimensional environment 350. Additionally, as shown in FIG. 3A, the three-dimensional environment 350 may include representations of book 311, writing utensil holder 312, and document 315 which are positioned atop the table 310 in the physical environment 318 in which the electronic device 301 is located. In some examples, the representations can include portions of the physical environment viewed through a transparent or translucent display of electronic device 301.

As mentioned above and as shown in FIG. 3A, the physical environment 318 includes the document 315, which optionally corresponds to a fillable form including a plurality of fillable fields (e.g., text-entry fields, image-entry fields, etc.). In some examples, the plurality of fillable fields of the document 315 prompts the user to provide (e.g., write, draw, etc.) information specific to one or more users, such as the user of the electronic device 301 or another user associated with the user of the electronic device 301 (e.g., a family member, a spouse or partner, a child or other family member, a friend, etc.). For example, as shown in FIG. 3A, the document 315 corresponds to a parking permit form and prompts the user to provide information relevant to parking a vehicle at a particular location (e.g., place of business, place of residence, etc.). As shown in FIG. 3A, the document 315 optionally includes a plurality of regions 316 (e.g., fillable fields), including a first region in which to indicate a name of the owner/operator (e.g., driver) of the vehicle (316-1), a second region in which to indicate a driver's license number of the person operating the vehicle (316-2), a third region in which to indicate a contact number (e.g., cellphone or telephone number) of the person operating the vehicle (316-3), a fourth region in which to indicate the make and model of the vehicle (316-4), and a fifth region in which to indicate the license plate number of the vehicle (316-5).

In certain situations, to reduce the cognitive burden of the user in filling out one or more regions in a respective document/form (e.g., document 315), it may be desirable to provide one or more user interface elements to the user that include suggested content (e.g., suggested text, images, etc.) that aid the user in filling out the one or more regions in the respective document. For example, the electronic device 301 may be configured to present one or more user interface elements in the three-dimensional environment 350 that aid the user in filling out the plurality of regions 316 in the document 315 (e.g., based on suggested text presented via the one or more user interface elements), as discussed in more detail below. Providing suggested content that aids a user in completing a particular form also reduces time consumption for the user, such as by reducing the time spent by the user locating and/or identifying the information needed to complete the form.

In some examples, the electronic device 301 displays one or more user interface elements including suggested text for aiding the user in filling out the fields in the document 315 in response to detecting user intent to interact with the document 315 (e.g., rather than solely based on detecting the document 315 in the field of view of the electronic device 301). For example, as shown in FIG. 3B, the electronic device 301 detects gaze 321 of the user directed to the first region 316-1 in the document 315 in the three-dimensional environment 350. In some examples, as shown in FIG. 3B, the electronic device 301 detects the gaze 321 is directed to the first region 316-1 for a threshold amount of time (e.g., 0.5, 1, 1.5, 2, 3, 5, 8, 10, 15, etc. seconds), represented by time 309 in time bar 308. Additionally or alternatively, in some examples, the electronic device 301 detects that alternatively timing criteria are satisfied (e.g., different from the gaze-based timing criterion above). For example, in FIG. 3B, the electronic device 301 detects that the first region 316-1 of the document 315 remains in the field of view of the user (and thus detectable by the one or more cameras of the electronic device 301) for at least a threshold amount of time (e.g., 1, 2, 3, 5, 10, 15, 20, 30, etc. seconds).

In some examples, as shown in FIG. 3B, in response to detecting the gaze 321 of the user directed to the first region 316-1 (e.g., for the threshold amount of time), the electronic device 301 displays user interface element 320-1 in the three-dimensional environment 350. In some examples, as mentioned above, the user interface element 320-1 includes suggested text (e.g., “Casey Williams”) for aiding the user in providing (e.g., writing) information in the first region 316-1. In some examples, the electronic device 301 generates the suggested text in the user interface element 320-1 based on detection of the first region 316-1 of the document 315. For example, the electronic device 301 utilizes image recognition, such as object recognition, character recognition, computer vision, or any other suitable detection technique, to identify one or more characteristics of the first region 316-1. In some examples, the electronic device 301 displays the suggested text in the three-dimensional environment 350 without the user interface element 320-1 (e.g., the suggested text Casey Williams is not necessarily contained within a virtual element). In some examples, the electronic device 301 detects the word “Name” included in the first region 316-1 (e.g., a text description or label of the content intended for the first region 316-1) and the presence of a line (or box or other spacing or blank (e.g., white space)) indicative of a text-entry field for which text or other content can be entered into (e.g., and for which text or other content has not already been entered into). In some examples, based on the recognition of the first region 316-1 as a text-entry field and the word “Name”, the electronic device 301 generates the suggested text Casey Williams, as discussed above, which is optionally the name of the user of the electronic device 301. In some examples, the user interface element 320-1 is displayed with any of the locking orientations defined herein. For example, the user interface element 320-1 (including the various user interface elements discussed below) may be displayed with a world-locked orientation, a body-locked orientation, or a head-locked orientation in the three-dimensional environment 350.

In some examples, the electronic device 301 generates the suggested text (e.g., Casey Williams) using data stored (e.g., in memory) and accessible by the electronic device 301. In some examples, the data is stored by the user of the electronic device 301 (e.g., the user provides input that is detected by the electronic device 301 for storing the data corresponding to the name Casey Williams). In some examples, the electronic device 301 generates the suggested text using data provided by an application running on the electronic device 301. For example, the electronic device 301 accesses a repository or library of user data from a contacts application (e.g., a digital phonebook), a web browsing application, a health or fitness application, a media player application, a photos application, a note taking application, etc. that enables the electronic device 301 to generate the suggested text corresponding to the detected word Name. In some examples, the data stored and accessible by the electronic device 301 corresponds to information captured by the electronic device 301 opportunistically (e.g., without user input causing the information to be captured by the electronic device 301. For example, if the electronic device 301 visually detects (e.g., via one or more cameras or other sensors) information in the physical environment that is determined to be relevant to the user, such as the license plate number of the user's vehicle, the driver's license number of the user, etc., the electronic device 301 may capture an image of and/or perform image recognition (e.g., optical character recognition) and store the information for use in generating suggested text. In some examples, the electronic device 301 generates the suggested text based on a type of object detected by the electronic device 301. For example, as discussed above, the document 315 corresponds to a parking permit form, which indicates (e.g., based on detecting “Parking Permit Form” title) that the information to be provided by the user relates to vehicles and other driving-related information associated with the user. In some examples, the electronic device 301 generates the suggested text, using the data discussed above, in accordance with a determination that the electronic device 301 has access (e.g., stored in memory or provided by an application) to data related to the first region 316-1. For example, if the electronic device 301 determines that information corresponding to a name (e.g., the name of the user or names of other users associated with the user of the electronic device 301) is not locatable, accessible, or otherwise known by the electronic device 301, the electronic device 301 forgoes displaying the user interface element 320-1 in the three-dimensional environment 350.

In some examples, the electronic device 301 provides the suggested text via the user interface element 320-1 in accordance with a determination that providing suggested content to the user is enabled at the electronic device 301. For example, provision of suggested content based on detection of one or more regions of an object (e.g., the document 315) in the physical environment 318 depends on whether a particular mode of operation is user-enabled (e.g., provided in a settings application on the electronic device 301). In some examples, the mode of operation in which suggested content is provided may be enabled for particular types of objects (e.g., documents) and not for other types of objects (e.g., locking devices, personal identification number (PIN) entry devices, etc.) detected by the electronic device 301. Accordingly, the electronic device 301 optionally is able to access data associated with the user (e.g., stored in memory as discussed above or provided by one or more applications running on the electronic device 301) if the user has opted in (e.g., provided user permission) and/or enabled the provision of suggested content.

In some examples, the electronic device 301 provides the suggested text via the user interface element 320-1 in accordance with a determination that the electronic device 301 is currently in an unlocked state (e.g., the electronic device 301 is not in a sleep mode). In some examples, the electronic device 301 provides the suggested text via the user interface element 320-1 in accordance with a determination that the user of the electronic device 301 has been authenticated. For example, the electronic device 301 is in an unlocked state and the user's identity and/or authorization to use the electronic device 301 has been verified using biometric authentication (e.g., fingerprint verification, facial identification, voice recognition, etc.). In some examples, the user authentication is performed one time (e.g., when the electronic device 301 is first powered on and/or accessed by the user (e.g., when the electronic device 301 is first positioned on the user's head)). In some examples, the user authentication is performed each time a suggestion is generated for the user (e.g., prior to displaying the user interface element 320-1 in the three-dimensional environment 350.

In some examples, the electronic device 301 generates suggested content based on a determined and/or predicted level of difficulty or complexity of content intended to be filled or entered into a respective region/field in the document 315. For example, as discussed above, the first region 316-1 includes the text description Name indicating that text corresponding to a particular name, such as the name of the user, is intended to be written in the first region 316-1 following the text description. In some examples, rather than displaying the suggested text Casey Williams in the three-dimensional environment 350 as discussed above and as shown in FIG. 3B, the electronic device 301 may forgo displaying the suggested text based on a determination that a level of difficulty of the content (e.g., a name) intended to be entered into the first region 316-1 is relatively low. For example, the electronic device 301 determines and/or predicts that the user is able to enter a particular name into the first region 316-1 (e.g., based on the user's memory and/or cognitive function) without the aid of the electronic device 301. On the other hand, for a more difficult or complex region (e.g., based on a length of the expected content), such as the fifth region 316-5 that prompts the user to enter a license plate number (or other similarly difficult types of content, such as vehicle identification numbers or user identification numbers), the electronic device 301 may display suggested text in the three-dimensional environment 350 for aiding the user in filling in the more difficult region. In some examples, the electronic device 301 generates the suggested text based on a determined confidence level of the electronic device 301 for the particular region (e.g., the first region 316-1). For example, the electronic device 301 displays the suggested text in the user interface element 320-1 in accordance with a determination that the confidence level for the first region 320-1 exceeds a threshold confidence (e.g., more than 75, 80, 85, or 90% confidence) based on one or more of the above factors.

In some examples, as shown in FIG. 3B, the electronic device 301 displays the user interface element 320-1 at a location in the three-dimensional environment 350 that is based on a location of the first region 316-1 in the document 315. For example, as shown in FIG. 3B, the user interface element 320-1 is displayed in the three-dimensional environment 350 at a location that is outside of a boundary or perimeter of the first region 316-1 in the document 315 (e.g., above the first region 320-1 relative to the viewpoint of the user). Additionally or alternatively, in some examples, the electronic device 301 displays the user interface element 320-1 at a location in the three-dimensional environment 350 that is at least a threshold distance (e.g., 0.1, 0.5, 1, 1.5, 2, 3, 4, etc. cm) of the first region 316-1 (e.g., relative to a center of the first region 316-1 or a particular portion of the first region 316-1, such as the Name label or the line adjacent to the Name label). In either case, the location at which the user interface element 320-1 is displayed in the three-dimensional environment 350 is different from the location corresponding to the first region 316-1 in the three-dimensional environment 350 (e.g., the locations do not overlap), which enables the user to easily enter content (e.g., write text) into the first region 316-1 while the user interface element 320-1 is displayed (e.g., without the user interface element occluding the field which the user intends to fill).

FIG. 3C illustrates an example in which the first region 316-1 discussed above is divided into or compounded into a first subregion 316-1a and a second subregion 316-1b (e.g., below the first subregion 316-1a or beside the first subregion 316-1a) in the document 315. For example, the Name label associated with the first region 316-1 discussed above is alternatively divided into a “First name” label and a “Last name” label, as shown in FIG. 3C. In some examples, in response to detecting the gaze 321 directed to the first subregion 316-1a, as shown in FIG. 3C, the electronic device 301 concurrently displays a first user interface element 320-1a and a second user interface element 320-1b in the three-dimensional environment 350. For example, because the first subregion 316-1a and the second subregion 316-1b share a same context (e.g., First name label and the Last name label collectively correspond to a name), the electronic device 301 concurrently displays the first user interface element 320-1a and the second user interface element 320-1b in the three-dimensional environment 350. Additionally or alternatively, in some examples, the electronic device 301 concurrently displays the first user interface element 320-1a and the second user interface element 320-1b in the three-dimensional environment 350 because user intent to interact with the document 315 is detected to be directed toward both the first subregion 316-1a and the second subregion 316-1b. For example, the electronic device 301 detects the gaze 321 directed to the first subregion 320-1a while an object associated with the user (e.g., a finger, pen, pencil, etc.) is directed to the second subregion 320-1b (as discussed in more detail herein later).

In some examples, as shown in FIG. 3C, the first user interface element 320-1a and the second user interface element 320-1b include suggested text corresponding to the suggested text provided in the user interface element 320-1 discussed above. For example, the first user interface element 320-1a provides suggested text indicating a first name of the user (e.g., “Casey”) and the second user interface element 320-1b provides suggested text indicating a last name of the user (e.g., “Williams”). As shown in FIG. 3C and as similarly discussed above, the first user interface element 320-1a is displayed at a first location that is based on a location corresponding to the first subregion 316-1a in the three-dimensional environment 350 and the second user interface element 320-1b is displayed at a second location that is based on a location corresponding to the second subregion 316-1b in the three-dimensional environment 350.

In some examples, the user may express intent to interact with a particular region in the document 315 via an object (e.g., a writing instrument) that is detectable by the electronic device 301. For example, as shown in FIG. 3D, the user is holding (e.g., in hand 306) writing instrument 303 (e.g., a pen, pencil, marker, etc.) that is visible in the field of view of the user in the physical environment 318. In some examples, the electronic device 301 visually detects (e.g., via one or more cameras of the electronic device 301) the writing instrument 303 is in contact with the document 315 (or that a tip of the writing instrument 303 is within a threshold distance from a surface of the document 315, such as 0.05, 0.1, 0.25, 0.5, 1, 2, etc. cm). Particularly, in FIG. 3D, the electronic device 301 detects the writing instrument 303 is in contact with the document 315 at a portion of the third region 316-3 discussed previously above. In some examples, the electronic device 301 detects the writing instrument 303 is in contact with the document 315 for at least a threshold amount of time, such as the threshold amount of time discussed previously above.

In some examples, as shown in FIG. 3D, in response to detecting the contact of the writing instrument 303 on the document 315 directed to the third region 316-3, the electronic device 301 generates suggested text corresponding to the third region 316-3. For example, as similarly discussed above, the electronic device 301 identifies one or more characteristics of the third region 316-3, such as the label “Cell phone” in the third region 316-3. In some examples, based on the identified label Cell phone in the third region 316-3, the electronic device 301 determines one or more cell phone numbers associated with the user of the electronic device 301. In some examples, in accordance with a determination that more than one cell phone number is identified as being associated with the user of the electronic device 301 (e.g., based on data stored in memory or provided by one or more applications running on the electronic device 301, as similarly discussed above), the electronic device 301 presents a plurality of user interface elements in the three-dimensional environment 350. For example, as shown in FIG. 3D, the electronic device 301 is concurrently displaying a third user interface element 320-2a and a fourth user interface element 320-2b in the three-dimensional environment 350. In some examples, as shown in FIG. 3D, the third user interface element 320-2a includes suggested text corresponding to a first cell phone number associated with the user and the fourth user interface element 320-2b includes suggested text corresponding to a second cell phone number associated with the user. In some examples, the suggested text in FIG. 3D is alternatively presented as a scrollable list (e.g., horizontally scrollable row, rather than a vertical list).

In some examples, the user may express intent to interact with a particular region in the document 315 via a gesture performed using a portion (e.g., hand) of the user that is detectable by the electronic device 301. For example, as shown in FIG. 3E, a hand 306 of the user is currently visible in the portion of the physical environment 318 that is included in the three-dimensional environment 350. In some examples, as shown in FIG. 3E, the electronic device 301 detects a gesture performed by the hand 306 directed to the document 315 in the physical environment 318. Particularly, in FIG. 3E, the electronic device 301 detects a finger (e.g., index finger) of the hand 306 is in contact with the document 315 (or that a tip of the finger is within a threshold distance from a surface of the document 315, such as 0.05, 0.1, 0.25, 0.5, 1, 2, etc. cm). In some examples, as shown in FIG. 3E, the electronic device 301 detects the finger is in contact with the document 315 at a location corresponding to the fourth region 316-4 discussed previously above. Alternatively, in some examples, the electronic device 301 detects a “pointing gesture” in which the index finger of the hand 306 is outstretched and directed toward the fourth region 316-4 of the document 315 (with or without necessarily detecting the index finger of the hand 306 in contact with the surface of the document 315). In some examples, the electronic device 301 detects an air pinch gesture (e.g., in which the index finger and thumb of the hand 306 come together to make contact) while the gaze of the user is directed toward the fourth region 316-4.

In some examples, as shown in FIG. 3E, in response to detecting the gesture performed by the hand 306 of the user directed toward the fourth region 316-4, the electronic device 301 generates suggested text to aid the user in entering text into the fourth region 316-4, as similarly discussed above. For example, as discussed above, the electronic device 301 identifies text label “Make/model” in the fourth region 316-4 and, based on data stored at the electronic device 301 or provided by one or more applications running on the electronic device 301, generates the suggest text “Model A Make A” as similarly discussed herein above. In some examples, as shown in FIG. 3E, the suggested text is displayed in user interface element 320-3 in the three-dimensional environment 350. In some examples, as similarly discussed above, the electronic device 301 displays the user interface element 320-3 at a location in the three-dimensional environment 350 that is based on a location corresponding to the fourth region 316-4 in the document 315 (e.g., outside of the location corresponding to the fourth region 316-4), as shown in FIG. 3E.

In FIG. 3F, the electronic device 301 detects handwritten text 322-1 in the first region 316-1 of the document 315 in the physical environment 318. For example, as shown in FIG. 3F, the electronic device 301 visually detects (e.g., via one or more cameras) the text “Jacob Smith” that has been written by the user using writing instrument 303 (e.g., held in hand 306 of the user) in the field of view of the user. In some examples, in FIG. 3F, the electronic device 301 detects that the tip of the writing instrument 303 is still in contact with the document 315 (e.g., the user is still writing the handwritten text 322-1). In some examples, when the electronic device 301 detects the handwritten text 322-1 (e.g., Jacob Smith), the electronic device 322-1 stores data corresponding to the text (e.g., the name Jacob Smith) for use in generating and displaying suggested text for the user later. For example, as similarly discussed above, if the electronic device 301 identifies a text label “Name” in a subsequent document, in response to detecting one of the triggers discussed above, the electronic device 301 may generate and display “Jacob Smith” as a suggestion for the user.

In FIG. 3G, the electronic device 301 detects liftoff of the tip of the writing instrument 303 from the surface of the document 315. For example, as shown in FIG. 3G, the tip of the writing instrument 303 is no longer contacting the document 315 and the user has concluded writing the handwritten text 322-1 into the first region 316-1 of the document 315.

In some examples, in response to detecting the liftoff of the tip of the writing instrument 3-3 from the surface of the document 315, as shown in FIG. 3G, the electronic device 301 generates suggested text for a proceeding (e.g., subsequent) region in the document 315. For example, as shown in FIG. 3G, the second region 316-2 spatially follows (e.g., is located below) the first region 316-1 and is thus determined by the electronic device 301 to be the proceeding region in the document 315. In some examples, the electronic device 301 determines the proceeding region based on a reading language of the text in the document 315. For example, based on the title of the document 315 (Parking Permit Form) and/or the text of the plurality of regions 316, the electronic device 301 determines that the document 315 reads from left to right (e.g., because English is a language that reads from left to right, top to bottom). Accordingly, following the left to right reading of the English language text in the document 315, the electronic device 301 determines that the second region 316-2 is the proceeding region in the document 315.

In some examples, as shown in FIG. 3G, the electronic device 301 generates suggested text for the second region 316-2 in the document 315 (e.g., the region proceeding the first region 316-1, as discussed above). For example, as similarly discussed herein, the electronic device 301 generates the suggested text “019000126” based on the detection of text label “Driver's license number” in the second region 316-2 in the document 315. In some examples, as shown in FIG. 3G, the suggested text is displayed in user interface element 320-4 in the three-dimensional environment 350. In some examples, the electronic device 301 displays the user interface element 320-4 in the three-dimensional environment 350 irrespective of whether the gaze 321 of the user is directed to the second region 316-2 of the document 315 in the portion of the physical environment 318 that is included in the three-dimensional environment 350. For example, as shown in FIG. 3G, despite the gaze 321 being directed to the second region 316-2 in the document 315, the electronic device 301 would display the user interface element 320-4 for the second region 316-2 even if the gaze 321 were detected as being directed to a region different from the second region 316-2. In some examples, as similarly discussed above, the electronic device 301 displays the user interface element 320-4 at a location in the three-dimensional environment 350 that is based on a location corresponding to the second region 316-2 (but not overlapping the location corresponding to the second region 316-2).

In FIG. 3H, the electronic device 301 detects handwritten text 322-2 in the second region 316-2 of the document 315. For example, as shown in FIG. 3H, the electronic device 301 detects that text “019000126” (e.g., corresponding to the suggested text in the user interface element 320-4) has been written in the second region 316-2 using writing instrument 303 (e.g., held in hand 306) by the user. In the example of FIG. 3H, the electronic device 301 detects that the tip of the writing instrument 303 is still in contact with the surface of the document 315.

In FIG. 3I, the electronic device 301 detects liftoff of the writing instrument 303 from the surface of the document 315 in the field of view of the user. For example, as shown in FIG. 3I, the electronic device 301 detects that the tip of the writing instrument 303 is no longer contacting the surface of the document 315 at the second region 316-2. In some examples, as shown in FIG. 3I, in response to detecting liftoff the writing instrument 303 from the document 315, the electronic device 301 ceases display of the user interface element 320-4 in the three-dimensional environment 350. In some examples, the electronic device 301 ceases display of the user interface element 320-4 in the three-dimensional environment 350 in response to detecting the handwritten text 322-2 in the second region 316-2 of the document 315. For example, the electronic device 301 determines that the handwritten text 322-2 in the second region 316-2 corresponds to the suggested text in the user interface element 320-4 (with or without necessarily detecting liftoff of the writing instrument 303 from the document 315), indicating that the user interface element 320-4 is no longer needed. Alternatively, in some examples, the electronic device 301 ceases display of the user interface element 320-4 after determining that a threshold amount of time (e.g., 1, 5, 10, 15, 20, 30, 60, etc. minutes) has elapsed since displaying the user interface element 320-4. As another example, the electronic device 301 ceases display of the user interface element 320-4 after detecting user intent to interact with a region that is different from the second region 316-2, such as detecting the gaze 321 or touchdown of a writing instrument directed to the third region 316-3 in the physical environment 318.

In some examples, as shown in FIG. 3I, after detecting liftoff of the writing instrument 303 from the document 315 and/or the gaze 321 directed to the third region 316-3 of the document 315, the electronic device 301 generates suggested text for aiding the user in entering text into the third region 316-3. For example, as similarly discussed above, the electronic device 301 detects the text label Cell phone in the third region 316-3. In some examples, the electronic device 301 adapts and/or updates the suggested text provided to the user based on text entered by the user (e.g., handwritten text) in other (e.g., previous) regions of the document 315. For example, as discussed above, in FIG. 3I, the user has written handwritten text 322-1 into the first region 316-1 of the document 315 and handwritten text 322-2 into the second region 316-2 of the document 315. Accordingly, the electronic device 301 generates suggested text for the detected third region 316-3 based at least in part on the handwritten text 322-1 and/or the handwritten text 322-2. In some examples, the electronic device 301 determines that the information being provided on the document 315 does not correspond to the user of the electronic device 301. For example, as discussed previously above, the user of the electronic device 301 is Casey Williams. As shown in FIG. 3I, the information being entered in the document 315 is for Jacob Smith who is different from Casey Williams (e.g., because Jacob Smith is currently using the electronic device 301 or Casey Williams is filling out the parking permit form for Jacob Smith). Accordingly, the electronic device 301 optionally generates suggested text corresponding to known cell phone numbers for Jacob Smith, rather than for Casey Williams (e.g., the known cell phone numbers for Casey Williams were shown previously in FIG. 3D).

In some examples, as shown in FIG. 3I, the electronic device 301 displays user interface element 320-5 in the three-dimensional environment 350 that includes suggested text generated based at least on the handwritten text 322-1 and/or 322-2. For example, as shown in FIG. 3I, the electronic device 301 generates the suggested text “(101) 788-1111” based on the handwritten text Jacob Smith (e.g., the suggested text corresponds to a known cell phone number for Jacob Smith). In some examples, as mentioned previously above, in accordance with a determination that the electronic device 301 is unable to locate and/or identify suggested text based on the name Jacob Smith, the electronic device 301 forgoes displaying the user interface element 320-5 in the three-dimensional environment 350 (or displays a known cell phone number, such as the cell phone number(s) associated with the user of the electronic device 301). Alternatively, in some examples, the electronic device 301 may display a visual indication that suggested text (or other content) is unable to be generated and/or that additional information is needed to generate the suggested text. In some examples, as similarly discussed herein, the electronic device 301 optionally displays the user interface element 320-5 at a location in the three-dimensional environment 350 that is based on a location corresponding to the third region 316-3 of the document (e.g., above the third region 316-3).

In FIG. 3J, the user of the electronic device 301 has provided additional handwritten text in the document 315 in the physical environment 318. For example, as shown in FIG. 3J, the user has provided handwritten text 322-3 (e.g., corresponding to the suggested text in the user interface element 320-5 discussed above) in the third region 316-3 of the document 315 and handwritten text 322-4 (e.g., corresponding to the suggested text in the user interface element 320-3 in FIG. 3E) in the fourth region 316-4 of the document 315. Additionally, in FIG. 3J, the electronic device 301 detects contact of the writing instrument 303 (e.g., held in hand 306 of the user) on the document 315. Particularly, as similarly discussed above, the electronic device 301 detects the tip of the writing instrument 303 on the document 315 at the fifth region 316-5.

In some examples, as shown in FIG. 3J, in response to detecting the writing instrument 303 on the document 315 at the fifth region 316-5, the electronic device 301 generates suggested text for aiding the user in entering text into the fifth region 316-5, as similarly discussed above. For example, as shown in FIG. 3J, the electronic device 301 displays user interface element 320-6 that includes suggested text “7TYP290” that corresponds to a known license plate number (e.g., a license plate number for the user's car and/or a car of another user associated with the user, such as John Smith as discussed above). In some examples, as shown in FIG. 3J, the user interface element 320-6 is displayed at a location in the three-dimensional environment 350 that is based on a location corresponding to the fifth region 316-5 of the document 315 (e.g., outside and/or above the fifth region 316-5).

In FIG. 3K, the electronic device 301 detects handwritten text 322-5 in the fifth region 316-5 of the document 315. For example, as shown in FIG. 3K, the user has written, using the writing instrument 303, the text “7TYP390” in the fifth region 316-5 of the document 315, which is currently visible in the field of view of the user.

In some examples, the electronic device 301 may be configured to detect errors (e.g., typographical errors, grammatical errors or inconsistencies, word usage errors, etc.) present in handwritten text provided in the document 315. In some examples, the electronic device 301 detects the errors based on a comparison between the handwritten text and the suggested text generated by the electronic device 301. For example, as shown in FIG. 3K, the electronic device 301 detects an error in the handwritten text 322-5 in the fifth region 316-5 of the document 315. Particularly, the electronic device 301 recognizes (e.g., via character recognition) that the number “2” in the suggested text in the user interface element 320-6 has been mistakenly written by the user as the number “3” in the handwritten text 322-5 (e.g., based on a comparison between 7TYP390 and 7TYP290). In some examples, the electronic device 301 may be configured to detect errors present in the handwritten text independent of whether suggested text was previously displayed in the three-dimensional environment 350 (e.g., such as the suggested text in the user interface element 320-6 discussed above). For example, the electronic device 301 is configured to detect typographical errors or other grammatical errors using a spell checker and/or a grammar checker running on the electronic device 301. Alternatively, in some examples, the electronic device 301 is configured to detect errors present in the handwritten text only if the suggested text was previously displayed (and/or is currently displayed) in the three-dimensional environment 350.

In some examples, as shown in FIG. 3K, when the electronic device 301 determines that the handwritten text 322-5 includes an error as discussed above, the electronic device 301 presents an alert indicating that the handwritten text 322-5 includes the error. For example, as shown in FIG. 3K, the electronic device 301 displays message 323 in the three-dimensional environment 350 alerting the user of the electronic device 301 of the detected error (e.g., “Incorrect Entry”). Additionally or alternatively, in some examples, the electronic device 301 provides a visual indication of the detected error with the handwritten text 322-5 in the three-dimensional environment 350. For example, as shown in FIG. 3K, the electronic device 301 displays indication 327 (e.g., jagged or etched underlining) below the portion of the handwritten text 322-5 containing the error, particularly below the number “3” in the handwritten text 322-5. In some examples, as shown in FIG. 3K, when the electronic device 301 detects the error in the handwritten text 322-5, the electronic device 301 updates display of the user interface element 320-6 to include indication 326 for aiding the user in correcting the error detected in the handwritten text 322-5. Particularly, as shown in FIG. 3K, the electronic device 301 optionally displays the indication 326 (e.g., underlining) below the portion of the suggested text to which the error corresponds, such as below the number “2” in the suggested text in the user interface element 320-6. Additionally or alternatively, in some examples, as shown in FIG. 3K, the electronic device 301 displays the portion of the suggested text to which the error corresponds with visual emphasis relative to the other portions of the suggested text to indicate to aid the user in correcting the error in the handwritten text 322-5. For example, in FIG. 3K, the electronic device 301 bolds or highlights or changes a color of the number “2” in the suggested text in the user interface element 320-6.

In some examples, as shown in FIG. 3K, the electronic device 301 displays the portion(s) of the suggested text that are detected to have been written correctly by the user (e.g., the portion(s) of the handwritten text 322-5 that match the portion(s) of the suggested text) with one or more indications that visually indicate the corresponding text in the handwritten text 322-5 is detected as being correct. For example, in FIG. 3K, the electronic device 301 displays indication 328 (e.g., dashed or patterned underlining) in the user interface element 320-6 below the portion(s) of the suggested text that are detected as being correctly written. Alternatively, in some examples, the electronic device 301 updates a visual appearance or visual emphasis of the portion(s) of the suggested text that are detected as being correctly written within the handwritten text 322-5. For example, the electronic device 301 may display the characters “7TYP” and “90” with a particular color (e.g., green, blue, etc.), shading, highlighting, or other patterning to indicate that the user has correctly written those portions of the suggested text in the handwritten text 322-5. In some examples, the electronic device 301 updates display of each character of the suggested text as the user writes the handwritten text 322-5 based on whether each character of the handwritten text 322-5 is detected as being correct or incorrect based on the suggested text. For example, in FIG. 3K, when the user writes the character “7” in the handwritten text 322-5, the electronic device 301 updates the corresponding character “7” in the suggested text of the user interface element 320-6 to have a first color (e.g., blue) because the handwritten character “7” is detected to be correct, and when the user later writes the character “3” in the handwritten text 322-5, the electronic device 301 updates the corresponding character “2” in the suggested text of the user interface element 320-6 to have a second color (e.g., red) because the handwritten character “2” is detected to be incorrect as similarly discussed above. In some such examples, if the user rewrites one or more portions of the handwritten text 322-5 to correct the detected error (e.g., erases and/or removes the character “3” and writes the character “2”), the electronic device 301 updates display of the suggested text in the user interface element 320-6 to have a third color (e.g., green) indicating that the whole of the suggested text has been correctly written by the user. In some examples, the validation of the input is performed on a per-character basis. For example, the system causes the suggested text transition from a first color to a second color for each character input correctly and/or transition from a first color to a third color for each character input incorrectly. In some examples, the validation of input is additionally or alternatively performed on a per-word basis or after completing entry of the suggested text (e.g., the complete license plate). For example, in addition to indicating correct or incorrect input on a per-character basis, the electronic device 301 can cause the suggested text to transition the characters making up the word(s) from the first, second, or third colors to a fourth color once all of the characters in the word are correctly entered. In some examples, the indication of validation of the input is part of an animation that ceases display of the suggested text.

Additionally or alternatively, in some examples, the electronic device 301 displays an indication 329 of the portions of the handwritten text 322-5 that are detected to have been written correctly by the user. For example, as shown in FIG. 3K, the electronic device 301 displays double underlining below the portions of the handwritten text 322-5 that correspond to and match the suggested text in the user interface element 320-6.

As discussed above, the electronic device 301 optionally determines that the handwritten text 322-5 includes an error based on a comparison between the handwritten text 322-5 and the suggested text in the user interface element 320-6. Particularly, the electronic device 301 determines that the handwritten text 322-5 corresponds to the suggested text in the user interface element 320-6 (e.g., based on detecting the same characters (e.g., numbers and letters) and in the same order above a threshold (e.g., more than three, four, five, or six characters are the same and appear in the same order between the handwritten text 322-5 and the suggested text)). Accordingly, the electronic device 301 identifies, based on the comparison, that the number “3” has been written in the handwritten text 322-5 where there should be the number “2” as discussed above. In some examples, if the electronic device 301 determines that the differences between the handwritten text 322-5 and the suggested text in the user interface element 320-6 exceed a threshold number (e.g., because the handwritten text 322-5 does not correspond to the suggested text), the electronic device 301 forgoes displaying the visual indications discussed above (e.g., message 323, indication 327, indication 326, indication 328, and/or indication 329) in the three-dimensional environment 350.

In some examples, the electronic device 301 displays the visual indications alerting the user of the detected error in the handwritten text 322-5 after detecting liftoff of the writing instrument 303 from the document 315. For example, in FIG. 3K, the electronic device 301 displays the message 323, the indication 327, the indication 328, and/or the indication 326 in the three-dimensional environment 350 in response to detecting that the user is no longer writing text in the document 315 (e.g., using the writing instrument 303). Alternatively, in some examples, the electronic device 301 displays the visual indications alerting the user of the detected error in the handwritten text 322-5 in real time (e.g., irrespective of whether the user is still writing text in the document 315). It should be understood that, while the indications 326, 327, 328 and 329 are illustrated in FIG. 3K and described above as being presented as underlining, alternative forms of indications may be provided, such as highlighting, color-changing, circling, boxing, strikethrough, etc.

As described previously above with reference to FIG. 3E, the electronic device 301 optionally generates suggested text in response to detecting a gesture performed by a hand of the user and that is directed to a particular region of the document 315 in the three-dimensional environment 350. Particularly, as discussed above, the electronic device 301 displays a user interface element including suggested text in the three-dimensional environment 350 in response to detecting a finger (e.g., index finger) of the hand in contact with the document 315 (or that a tip of the finger is within a threshold distance from a surface of the document 315, such as 0.05, 0.1, 0.25, 0.5, 1, 2, etc. cm).

In some examples, as shown in FIG. 3L, the electronic device 301 detects a gesture and/or pose (e.g., a pointing gesture or pose using the index finger for pointing) performed by the hand 306 of the user directed toward the fourth region 316-4 of the document 315 in the three-dimensional environment 350, as similarly discussed above. For example, as shown in FIG. 3L, the electronic device 301 detects a tip of the index finger of the hand 306 directed to the text label “Make/model” in the fourth region 316-4 (e.g., the tip of the index finger is positioned below the words Make/model and/or over/on the words “Make/model,” without necessarily being in contact with the surface of the document 315 as similarly discussed above). In some examples, the electronic device 301 detects a pointing pose of the hand 306 in addition to detecting the index finger (e.g., the electronic device 301 detects other fingers of the hand 306 curled inward toward the palm of the hand 306).

In some examples, in response to detecting the gesture performed by the hand 306 of the user directed toward the fourth region 316-4, the electronic device 301 generates suggested text to aid the user in entering text into the fourth region 316-4 in accordance with a determination that the gesture is detected (e.g., the hand 306 maintains the gesture) for at least a threshold amount of time, such as 0.5, 1, 1.5, 2, 3, 5, 8, 10, etc. seconds. In some examples, in response to detecting the gesture performed by the hand 306 directed toward the fourth region 316-4, the electronic device 301 displays visual indicator 335 that is associated with the threshold amount of time, represented by time 341 in time bar 340 in FIG. 3L. For example, as shown in FIG. 3L, the electronic device 301 displays a representation of a hand that is displayed with an animation indicative of the elapsing of the threshold amount of time, such as visualized filling in and/or populating of the visual indicator 335 as represented by shading 336. Accordingly, in the example of FIG. 3L, an amount that the visual indicator 335 is filled-in/populated (e.g., via the shading 336) in the three-dimensional environment 350 corresponds to (e.g., is equal to or is proportional to) an amount of time that has elapsed since detecting the gesture performed by the hand 306, as represented in the time bar 340. In some examples, the visual indicator 335 is displayed at a location in the three-dimensional environment 350 that is based on the hand 306 (e.g., a location of the hand 306 in the three-dimensional environment 350). For example, as shown in FIG. 3L, the electronic device 301 displays the visual indicator 335 at a location adjacent to (e.g., to the right of) the hand 306 (e.g., the portion of the hand 306 that is visible via passthrough) in the three-dimensional environment 350. Alternatively, in some examples, the visual indicator 335 is displayed at a predetermined location in the three-dimensional environment 350, such as at a location corresponding to a center of the field of view of the electronic device 301 or at a location corresponding to a corner or edge of the display of the electronic device 301. Additionally, in the example of FIG. 3L, because the threshold amount of time has not elapsed since detecting the gesture performed by the hand 306, the electronic device 301 forgoes displaying a user interface element including suggested text in the three-dimensional environment 350.

In some examples, as shown in FIG. 3M, in accordance with a determination that the threshold amount of time, represented by time 341 in the time bar 340, has elapsed since detecting the gesture performed by the hand 306 and the hand 306 has maintained the gesture for the threshold amount of time, the electronic device 301 displays the user interface element 320-3 that includes suggested text (e.g., “Model A Make A”) for aiding the user in entering text into the fourth region 316-4. In some examples, the user interface element 320-3 corresponds to the user interface element 320-3 discussed above with reference to FIG. 3E. In some examples, as shown in FIG. 3M, because the threshold amount of time described above has elapsed, the visual indicator 335 (e.g., the representation of the hand) is updated in the three-dimensional environment 350 to visually appear to be completely filled in/populated, visually signifying that the user has maintained the gesture for the amount of time required for displaying the user interface element 320-3 in the three-dimensional environment 350. In some examples, the electronic device 301 ceases display of the visual indicator 335 after detecting that the hand 306 is no longer performing the gesture discussed above (e.g., the index finger of the hand 306 is no longer pointing at and/or contacting the text label Make/model in the fourth region 316-4). In some examples, the electronic device 301 ceases display of the visual indicator 335 after displaying the user interface element 320-3 in the three-dimensional environment 350. As another example, the electronic device 301 may cease display of the visual indicator 335 in the three-dimensional environment 350 in accordance with a determination that the user has correctly entered/written text in the fourth region 316-4 with respect to the suggested text of the user interface element 320-3, as similarly discussed above with reference to FIG. 3K.

In some examples, if the electronic device 301 detects the hand 306 cease performing the gesture using the hand 306 directed to the document 315 before the threshold amount of time, represented by time 341, elapses, the electronic device 301 forgoes displaying the user interface element 320-3 in the three-dimensional environment 350. Additionally, in such an instance, the electronic device 301 optionally ceases display of the visual indicator 335 in the three-dimensional environment 350, visually signifying that the user has not maintained the gesture using the hand 306 for the amount of time required for displaying the user interface element 320-3 in the three-dimensional environment 350. Further, in such an example, if the user were to reperform the gesture discussed above using the hand 306 directed to the document 315, the electronic device 301 may restart tracking elapsing of the threshold amount of time (e.g., from zero) rather than from the instance relative to the threshold amount of time at which the user ceased performing the gesture. As an alternative example, if the electronic device 301 detects the hand 306 cease performing the gesture and/or the pose using the hand 306 directed to the document 315 before the threshold amount of time discussed above elapses, the electronic device 301 reverses the animation (e.g., represented by the shading 336) of the visual indicator 335. For example, the electronic device 301 reverses the filling in/populating of the visual indicator 335, such that the visual indicator 335 appears to be emptying in the three-dimensional environment 350, during which time the user may reperform the gesture discussed above to resume the elapsing of the threshold amount of time required for displaying the user interface element 320-3 in the three-dimensional environment 350. In some such examples, a timing of the emptying of the visual indicator 335 may be different from the timing associated with the filling in/populating of the visual indicator 335 (e.g., which is equal to the threshold amount of time as discussed above). For example, the electronic device 301 may, via the animation (e.g., represented by the shading 336) of the visual indicator 335, empty the visual indicator 335 faster than the filling in of the visual indicator 335 in the three-dimensional environment 350 (or vice versa), or utilize some other timing mechanisms.

In some examples, the electronic device 301 displays the user interface element 320-3 at a predetermined location in the three-dimensional environment 350, rather than at a location that is based on the fourth region 316-4 as discussed previously above. For example, as shown in FIG. 3M, the electronic device 301 displays the user interface element 320-3 at a location that corresponds to a center of the field of view of the electronic device 301, rather than at a location above and/or adjacent to the fourth region 316-4 in the three-dimensional environment 350. In some such examples, the user interface element 320-3 is displayed as a world-locked object in the three-dimensional environment 350.

In some examples, the suggested text of the user interface element 320-3 is displayed with a visual indication of a source of information used in the generation of the suggested text. For example, as discussed previously above, the suggested text Model A Make A in the user interface element 320-3 may be generated based on application data, user data stored in memory (e.g., in a file) and/or otherwise accessible by the electronic device 301 (e.g., in a cloud database or on a second electronic device). In some examples, as shown in FIG. 3M, the user interface element 320-3 may include a name, title, label, etc. of the source of the information, such as a name and/or icon corresponding to the particular application that provided the data to generate the suggested text Model A Make A and/or a name of a file stored in memory that the electronic device 301 used to generate the suggested text (e.g., “Found in Files”). In some examples, as shown in FIG. 3M, the visual indication of the source of the information may be displayed below the suggested text in the user interface element 320-3. Additionally, in some examples, the electronic device 301 may display the suggested text with additional information that is based on the context of the fourth region 316-4 (e.g., the text label Make/model). For example, as shown in FIG. 3M, the user interface element 320-3 includes information corresponding to a vehicle identification number (VIN) associated with the Model A Make A. In some examples, the suggested text Model A Make A may be visually delineated from the other information included in the user interface element 320-3 (e.g., the VIN and the source of the information) to visually and/or clearly indicate to the user the suggested text that has been generated by the electronic device 301 for filling in the fourth region 316-4. For example, as shown in FIG. 3M, the suggested text Model A Make A may be displayed at a largest size within the user interface element 316-4 and/or with bold font, while the VIN and the source of the information are displayed at smaller sizes and/or without bold font in the user interface element 316-4.

It should be understood that the visual indicator 335 described above is exemplary and that the visual indicator 335 may have an alternative appearance when displayed in the three-dimensional environment 350. For example, the visual indicator 335 may alternatively be displayed as a circular object, such as a dot, circle, sphere, or similar object, or as any other suitably shaped object in the three-dimensional environment 350. It should be understood that, in such an instance, presentation of the animation of filling in/populating the visual indicator 335 (e.g., similar to the shading 336) may be maintained for the alternative form of the visual indicator 335.

Attention is now directed to additional examples of visually detecting one or more regions of a physical object in the physical environment and displaying one or more user interface elements including suggested content in a three-dimensional environment.

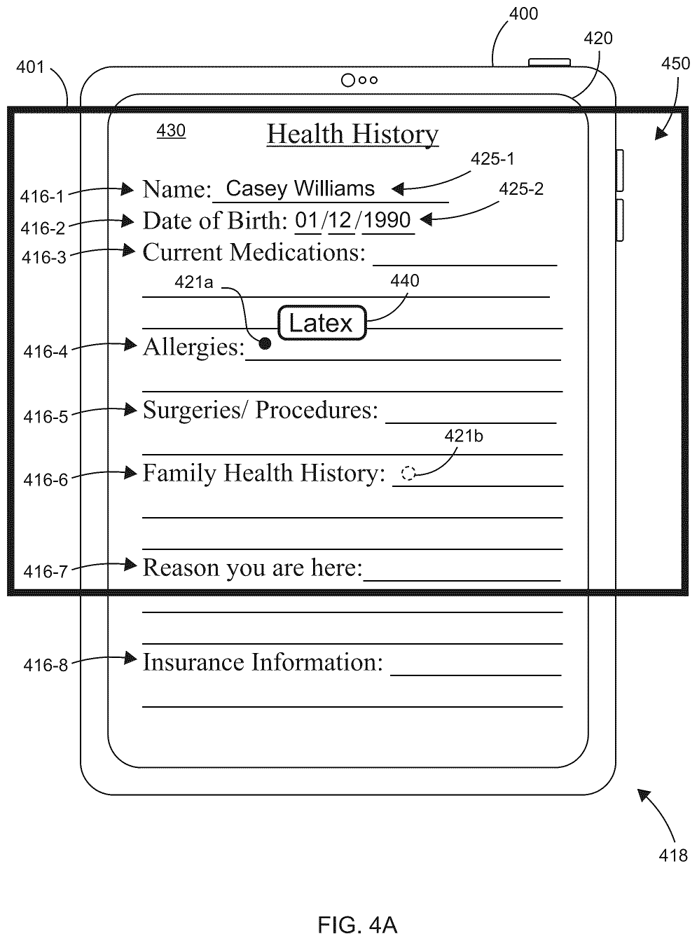

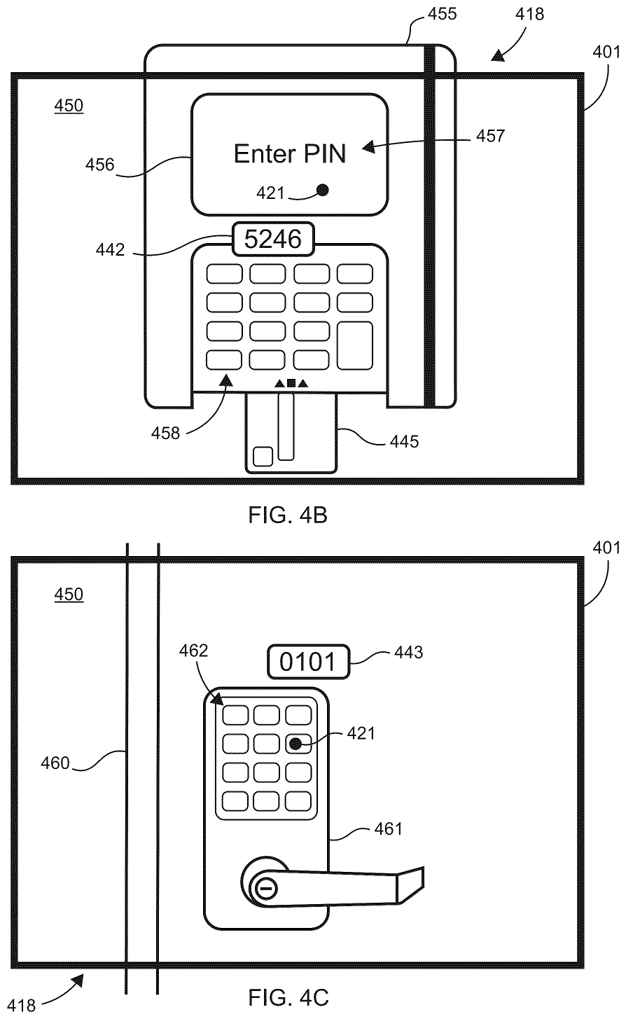

FIGS. 4A-4C illustrate examples of an electronic device displaying user interface elements including suggested text based on detection of one or more regions of a physical object according to some examples of the disclosure. In some examples, electronic device 401 has one or more characteristics of electronic device 301 discussed above. For example, the electronic device 401 may be a head mountable system/device and/or projection-based system/device (including a hologram-based system/device) configured to generate and present a three-dimensional environment. In the example of FIGS. 4A-4C, a user is optionally wearing the electronic device 401, such that three-dimensional environment 450 (e.g., a computer-generated environment) can be defined by X, Y and Z axes as viewed from a perspective of the electronic device (e.g., a viewpoint associated with the user of the electronic device 401), as similarly discussed above. In some examples, the three-dimensional environment 450 has one or more characteristics of three-dimensional environment 350 discussed above.

As shown in FIG. 4A, the electronic device 401 may be positioned in a physical environment 418 that includes a plurality of real-world objects. For example, in FIG. 4A, the physical environment 418 includes second electronic device 400. The second electronic device 400 may be similar to electronic device 201 discussed above, and/or may be a mobile device, such as a smartphone, a tablet, or a laptop, or a desktop computer. In some examples, the second electronic device 400 includes one or more components similar to electronic device 201 in FIG. 2, such as one or more touch-sensitive surfaces, one or more microphones or other audio sensors, one or more display generation components, one or more speakers, one or more processors, one or more memories, and/or communication circuitry. For example, as shown in FIG. 4A, the second electronic device 400 includes touchscreen 420 that is configured to display one or more user interfaces and detect touch-based input. In some examples, the physical environment 418 has one or more characteristics of physical environment 318 described above.

In some examples, as similarly discussed above, the three-dimensional environment 450 presented using the electronic device 401 optionally includes captured portions of the physical environment 418 surrounding the electronic device 401, such as a representation of the second electronic device 400 in the field of view of the three-dimensional environment 450. In some examples, as shown in FIG. 4A, the second electronic device 400 is displaying user interface 430 on the touchscreen 420, as discussed in more detail below. Accordingly, as shown in FIG. 4A, the three-dimensional environment 450 may include a representation of the user interface 430 that is displayed on the second electronic device 400 in the physical environment 418. In some examples, the representations can include portions of the physical environment viewed through a transparent or translucent display of electronic device 401.

In some examples, as mentioned above, the second electronic device 400 is displaying the user interface 430. In some examples, the user interface 430 corresponds to a digital document (e.g., a digital form) including a plurality of regions (e.g., fillable fields) into which content may be entered, such as text, images, drawings, etc. For example, as shown in FIG. 4A, the user interface 430 includes a plurality of regions 416 that are configured to receive content (e.g., the plurality of regions 416 is selectable to enter text or other content into each region in the user interface 430). In some examples, the digital document of the user interface 430 corresponds to a health history form that prompts the user of the electronic device 401 to provide information related to a health history of a particular patient, such as the user or another person associated with the user of the electronic device 401 (e.g., a spouse or partner, a child or other family member, a friend, etc.). In some examples, the user interface 430 includes a first region in which to indicate a name of a patient (416-1), a second region in which to indicate a date of birth of the patient (416-2), a third region in which to indicate medications, if any, the patient is currently prescribed and/or consuming (416-3), a fourth region in which to indicate allergies, if any, the patient has (416-4), a fifth region in which to indicate surgeries or other major procedures, if any, the patient has undergone (416-5), a sixth region in which to indicate family health history, such as a history of disease, cancer, mental health illnesses, or other conditions, of the patient (416-6), a seventh region in which to indicate the patient's reason for visiting the medical office (416-7), and an eighth region in which to indicate the patient's insurance information (416-8). In FIG. 4A, the eighth region 416-8 is optionally outside of the user's field of view of the three-dimensional environment 450 and is thus optionally not visually detectable by the electronic device 401.

In FIG. 4A, the user has entered text into one or more regions of the user interface 430. For example, as shown in FIG. 4A, the first region 416-1 includes text 425-1 indicating the name of the patient with which the health history information in the user interface 430 is associated (e.g., “Casey Williams”). In some examples, Casey Williams corresponds to the name of the user of the electronic device 401. Additionally, as shown in FIG. 4A, the second region 416-2 includes text 425-2 indicating the date of birth of the patient with which the health history information in the user interface 430 is associated (e.g., “Jan. 12, 1990”). In some examples, the text 425-1 and 425-2 is entered into the first region 416-1 and the second region 416-2, respectively, via a digital keyboard of the second electronic device 400 (e.g., in response to the second electronic device 400 detecting a tap of a contact (e.g., a finger, stylus, or other object) on the touchscreen 420 directed to the first region 416-1 and the second region 416-2). Alternatively, in some examples, the text 425-1 and 425-2 is entered into the first region 416-1 and the second region 416-2, respectively, in response to the second electronic device 400 detecting (e.g., via one or more microphones) audio-based input (e.g., dictation).

In some examples, as similarly discussed above with reference to FIGS. 3A-3M, it may be advantageous to provide a method of suggesting content based on the detection of one or more regions of the user interface 430 displayed at the second electronic device 400 in the physical environment 418 to aid the user in entering content into the one or more regions, as opposed to solely relying on such a method at the second electronic device 400. For example, the second electronic device 400 may be an electronic device that is not configured to (e.g., automatically) suggest content to the user based on the regions in the user interface 430. As another example, the second electronic device 400 may be an electronic device that does not belong to the user of the electronic device 401 and thus does not have access (e.g., in memory or applications running on the second electronic device 400) to user data of the user of the electronic device 401. For example, as discussed above, the user interface 430 corresponds to a health history form and the user may be filling out the health history form at a doctor's office via the second electronic device 400 belonging to the doctor's office. Additionally or alternatively, the user is filling out the health history form of the user interface 430 for another person whose information is not stored on and/or accessible by the second electronic device 400 (while the user's information is).

In FIG. 4A, the electronic device 401 detects gaze 421a of the user directed to the fourth region 416-4 of the user interface 430 in the three-dimensional environment 450. For example, as shown in FIG. 4A, the electronic device 401 detects the gaze 421a directed to a location in the three-dimensional environment 450 that corresponds to a location of the fourth region 416-4 displayed by the second electronic device 400. Alternatively, in some examples, the electronic device 401 detects a gesture performed by a portion of the user, such as a pointing gesture provided by a finger of the user directed to the fourth region 416-4 of the user interface 430.

In some examples, as similarly discussed herein above, in response to detecting the gaze 421a directed to the fourth region 416-4, the electronic device 401 generates suggested text for aiding the user in entering text into the fourth region 416-4. For example, in FIG. 4A, the electronic device 401 detects (e.g., using character recognition) the text label “Allergies” in the fourth region 416-4 and identifies, using data stored in memory at the electronic device 401 or provided by an application running on the electronic device 401, such as a health application, information corresponding to known allergies of the user. In some examples, as similarly discussed above, the electronic device 401 generates the suggested text based on previous text entered into the user interface 430 by the user, such as the text 425-1 (e.g., Casey Williams) in the first region 416-1. As shown in FIG. 4A, the electronic device 401 displays user interface element 440 that includes suggested text (e.g., “Latex”) corresponding to a known allergy of the patient (e.g., the user of the electronic device 401). In some examples, as similarly described above, the electronic device 401 displays the user interface element 440 at a location in the three-dimensional environment 450 based on a location corresponding to the fourth region 416-4 in the user interface 430. For example, as shown in FIG. 4A and as similarly discussed previously above, the electronic device 401 displays the user interface element 440 above the fourth region 416-4 in the user interface 430 (e.g., at a location outside the fourth region 416-4 in the user interface 430). In some examples, the user interface element 440 has one or more characteristics of the user interface elements described with reference to FIGS. 3A-3M above.

In some examples, as shown in FIG. 4A, the electronic device 401 alternatively detects the gaze 421b of the user directed to the sixth region 416-6 in the user interface 430 in the three-dimensional environment 450. For example, the electronic device 401 detects the gaze 421b of the user directed to the sixth region 416-6 instead of detecting the gaze 421a directed to the fourth region 416-4 as discussed above or at a different time (e.g., before or after detecting the gaze 421a directed to the fourth region 416-4). In some examples, in response to detecting the gaze 421b directed to the sixth region 416-6, the electronic device 401 forgoes displaying a user interface element for aiding the user in entering text into the sixth region 416-6, as shown in FIG. 4A. For example, as similarly discussed above, the electronic device 401 visually detects the text label “Family Health History” in the sixth region 416-6 and initiates locating of information corresponding to a family health history of the user (e.g., Casey Williams). In some examples, as indicated in FIG. 4A, the electronic device 401 is unable to generate suggested text based on the characteristics of the sixth region 416-6. For example, the electronic device 401 is unable to locate information corresponding to the family health history of the user in user data stored in memory or in user data provided by applications running on the electronic device 401. As another example, the electronic device 401 is unable to generate the suggested text for the sixth region 416-6 because the text label Family Health History produces a vast number of options (e.g., too many options to display in a given user interface element in the three-dimensional environment 450) and/or is too broad a topic for singling out one or more options for generating suggested text. In some examples, the electronic device 401 is unable to generate the suggested text for the sixth region 416-6 because the topic relating to family health history of the user is not applicable for the patient (e.g., because the patient (Casey Williams) does not have a known family health history of certain diseases, cancers, mental health illnesses, or other conditions).

FIG. 4B illustrates an example of the electronic device 401 displaying the three-dimensional environment 450 that includes a credit card machine 455 in the physical environment 418. For example, while displaying the three-dimensional environment 450 discussed above, the electronic device 401 visually detects the credit card machine 455 in the field of view of the user in the portion of the physical environment 418 that is included in the three-dimensional environment 450 (e.g., at a checkout station or other payment station). In some examples, as shown in FIG. 4B, the credit card machine 455 includes display 456 and PIN pad 458. Accordingly, as shown in FIG. 4B, the three-dimensional environment 450 includes representations of the credit card machine 455 and the PIN pad 458, optionally as computer-generated representations or as passthrough representations.

In FIG. 4B, the user of the electronic device 401 is currently initiating payment for goods. For example, as shown in FIG. 4B, a payment card 445 (e.g., a credit card, debit card, gift card, etc.) has been inserted into the credit card machine 455 for processing of the payment. In FIG. 4B, the credit card machine 455 is displaying text indication 457 on the display 456 prompting the user to enter the PIN associated with the payment card 445 for completing the processing of the payment (e.g., “Enter PIN”).

In FIG. 4B, while the credit card machine 455 is displaying the text indication 457 on the display 456, the electronic device 401 detects the gaze 421 of the user directed to the display 456 and/or the text indication 457 in the three-dimensional environment 450. Alternatively, in some examples, the electronic device 401 detects a gesture performed by a portion of the user, such as a pointing gesture provided by a finger of the user directed to the display 456 or the PIN pad 458.

In some examples, as shown in FIG. 4B, in response to detecting the gaze 421 of the user directed to the display 456, the electronic device 401 displays user interface element 442 in the three-dimensional environment 450. In some examples, as similarly discussed herein, the user interface element 442 includes suggested text, particularly a suggested PIN associated with the payment card 445 (e.g., “5246”). In some examples, the electronic device 401 generates the suggested text in the user interface element 442 based on one or more characteristics of the objects currently visible in the field of view of the user. For example, as discussed above, the text indication 457 prompts the user to provide a PIN for the payment card 445 that is currently inserted into the credit card machine 455. In some examples, the electronic device 401 is configured to visually detect (e.g., via one or more cameras of the electronic device 401) the payment card 445 in the field of view of the user. Particularly, the electronic device 401 may detect (e.g., via object recognition, computer vision, or other image recognition techniques) at least a portion of the card number of the payment card 445, a visual appearance of the payment card 445 (e.g., color and/or design), a type of card, and/or the institution (e.g., bank, credit agency, or other lender) with which the payment card 445 is associated to identify the particular card being used. Once the payment card 445 is identified, the electronic device 401 optionally locates information corresponding to the payment card 445 stored in memory at the electronic device 401 or via user data provided by one or more applications running on the electronic device 401, such as a digital wallet application, a banking application, a note taking application, etc. In some examples, as shown in FIG. 4B and as similarly discussed above, the electronic device 401 displays the user interface element 442 at a location in the three-dimensional environment 450 based on a location corresponding to the display 456 and/or the PIN pad 458. For example, as shown in FIG. 4B, the electronic device 401 displays the user interface element 442 below the display 456 and/or above the PIN pad 458 to aid the user in selecting the appropriate buttons on the PIN pad 458 for completing the transaction discussed above. In some examples, the user interface element 442 has one or more characteristics of the user interface elements described with reference to FIGS. 3A-3M above.

FIG. 4C illustrates an example of the electronic device 401 displaying the three-dimensional environment 450 that includes an electronic door lock 461 in the physical environment 418. For example, while displaying the three-dimensional environment 450 discussed above, the electronic device 401 visually detects the electronic door lock 461 in the field of view of the user in the portion of the physical environment 418 that is included in the three-dimensional environment 450 (e.g., at a front door of a house, apartment building, office, etc.). In some examples, as shown in FIG. 4C, the electronic door lock 461 includes keypad 462 comprising a plurality of selectable keys. Accordingly, as shown in FIG. 4C, the three-dimensional environment 450 includes representations of the electronic door lock 461 and the keypad 462, optionally as computer-generated representations or as passthrough representations.

In FIG. 4C, the user of the electronic device 401 is currently initiating unlocking of the electronic door lock 461 for passage through door 460 in the physical environment 418. For example, in FIG. 4C, the door 460 is currently closed and the electronic door lock 461 is in a locked state, requiring the user of the electronic device 401 to enter a particular code to unlock the electronic door lock 461.

In FIG. 4C, the electronic device 401 detects the gaze 421 of the user directed to the keypad 462 of the electronic door lock 461 in the three-dimensional environment 450. Alternatively, in some examples, the electronic device 401 detects a gesture performed by a portion of the user, such as a pointing gesture provided by a finger of the user directed to the keypad 462.

In some examples, as shown in FIG. 4C, in response to detecting the gaze 421 of the user directed to the keypad 462, the electronic device 401 displays user interface element 443 in the three-dimensional environment 450. In some examples, as shown in FIG. 4C, the user interface element 443 includes suggested text corresponding to a suggested key code for unlocking the electronic door lock 461 (e.g., “0101”). In some examples, the electronic device 401 generates the suggested text based on one or more characteristics of the objects in the user's field of view. For example, in FIG. 4C, the electronic device 401 visually detects the electronic door lock 461 in the field of view of the user, including a visual appearance of the electronic door lock 461, a brand of the electronic door lock 461, a visual appearance of the door 460, and/or a visual appearance of the keypad 462. Additionally, in some examples, the electronic device 401 determines the user's current location, which optionally corresponds to the location of the electronic device 401 (e.g., using GPS). Based on the detection of the above environmental factors, the electronic device 401 optionally determines the particular electronic door lock that is in the field of view of the user (e.g., the user's front door at home versus the front door at the user's place of work). As similarly discussed herein above, the electronic device 401 optionally locates information stored in memory of the electronic device 401 or provided by one or more applications running on the electronic device 401 relating to the key code for the electronic door lock 461. For example, the electronic device 401 has previously detected and captured an image of (or otherwise stored data corresponding to) the user entering the key code for the electronic door lock 461 (e.g., which caused the electronic door lock 461 to be unlocked). In some examples, the electronic device 401 identifies the key code based on user data provided by a note taking application (e.g., which includes user-entered notes relating to passwords, key codes, and PINs), a messaging application (e.g., text or email), an application facilitating homestays and experiences (e.g., housing rentals), or other application.

In some examples, as shown in FIG. 4C and as similarly discussed above, the electronic device 401 displays the user interface element 443 at a location in the three-dimensional environment 450 based on a location corresponding to the keypad 462. For example, as shown in FIG. 4C, the electronic device 401 displays the user interface element 443 above the keypad 462 to aid the user in selecting the appropriate keys on the keypad 462 for unlocking the door 460. In some examples, the user interface element 443 has one or more characteristics of the user interface elements described with reference to FIGS. 3A-3M above.

It is understood that the examples shown and described herein are merely exemplary and that additional and/or alternative elements may be provided within the three-dimensional environment relating to the display of suggested content for the user. It should be understood that the appearance, shape, form and size of each of the various user interface elements and objects shown and described herein are exemplary and that alternative appearances, shapes, forms and/or sizes may be provided. For example, the various user interface elements including suggested text (e.g., user interface elements 320, 440, 442 and 443) may be provided in an alternative shape than a rectangular shape, such as a circular shape, triangular shape, etc. Additionally or alternatively, in some examples, the various user interface elements described herein may be selected and/or manipulated via user input received via one or more separate input devices in communication with the electronic device(s). For example, where applicable, selection input (e.g., for initiating tracking of the exercise activity) may be received via physical input devices, such as a mouse, trackpad, keyboard, etc. in communication with the electronic device(s). Additionally, in some examples, suggesting content to the user may include suggesting non-alphanumeric content. For example, if a particular region in a form or document presents a list of options (e.g., radio buttons or option buttons) from which the user is able to select one or more options applicable to the user, the electronic device may display one or more of the options in the list of options with a visual indication (e.g., highlighting, underlining, circling, pointed arrow, etc.) indicating those options are suggested for the user by the electronic device 301 according to the manner(s) discussed above.

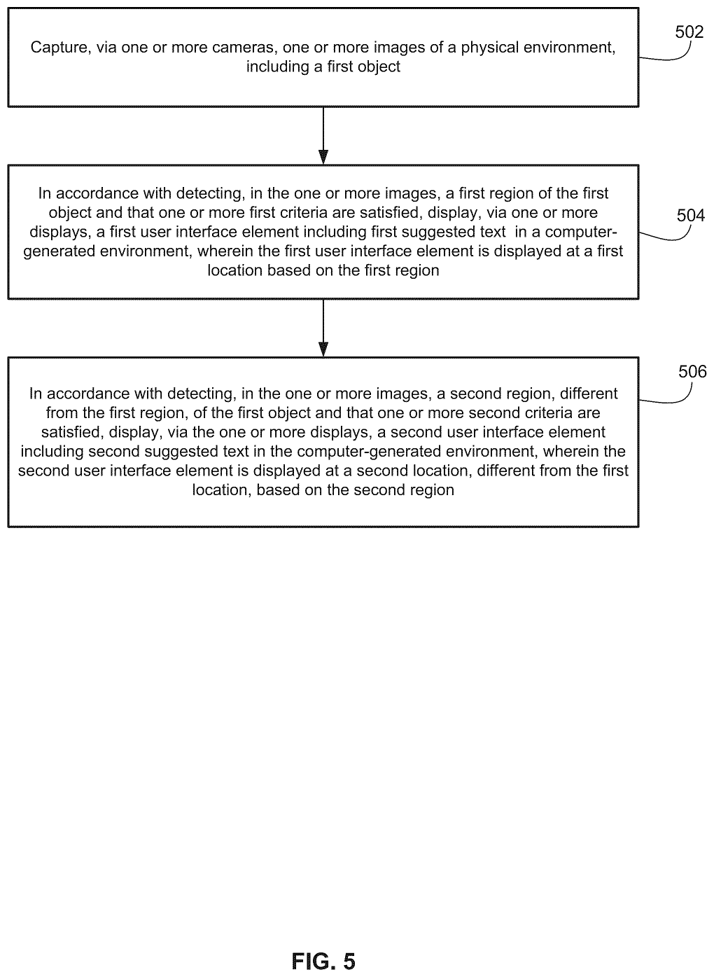

FIG. 5 is a flow diagram illustrating an example process for displaying a user interface element including suggested text based on detection of a region of a physical object according to some examples of the disclosure. In some examples, process 500 begins at an electronic device in communication with one or more displays, one or more input devices, and one or more cameras. In some examples, the electronic device is optionally a head-mounted display similar or corresponding to electronic device 201 of FIG. 2. As shown in FIG. 5, in some examples, at 502, the electronic device captures, via the one or more cameras, one or more images of a physical environment, including a first object. For example, as illustrated in FIG. 3A, the electronic device 301 detects document 315 in physical environment 318 that is visible in three-dimensional environment 350 presented at the electronic device 301.

In some examples, at 504, in accordance with detecting, in the one or more images, a first region of the first object and that one or more first criteria are satisfied, the electronic device displays, via the one or more displays, a first user interface element including first suggested text in a computer-generated environment, wherein the first user interface element is displayed at a first location based on the first region. For example, as described with reference to FIG. 3B, the electronic device 301 detects first region 316-1 of the document 315 and that gaze 321 of the user is directed to the first region 316-1 in the three-dimensional environment 350. Accordingly, as shown in FIG. 3B, the electronic device 301 displays user interface element 320-1 that includes suggested text (e.g., “Casey Williams”) for aiding the user in entering text into the first region 316-1. In some examples, as described with reference to FIG. 3B, the user interface element 320-1 is displayed at a location in the three-dimensional environment 350 that is outside of the first region 316-1.

In some examples, at 506, in accordance with detecting, in the one or more images, a second region, different from the first region, of the first object and that one or more second criteria are satisfied, the electronic device displays, via the one or more displays, a second user interface element including second suggested text in the computer-generated environment, wherein the second user interface element is displayed at a second location, different from the first location, based on the second region. For example, as described with reference to FIG. 3E, the electronic device 301 detects fourth region 316-4 of the document 315 and that a finger of hand 306 of the user is directed to the fourth region 316-4 (e.g., is contacting the surface of the document 315 at the fourth region 316-4) in the three-dimensional environment 350. Accordingly, as shown in FIG. 3E, the electronic device 301 displays user interface element 320-3 that includes suggested text (e.g., “Model A Make A”) for aiding the user in entering text into the fourth region 316-4. In some examples, as described with reference to FIG. 3E, the user interface element 320-3 is displayed at a location in the three-dimensional environment 350 that is outside of the fourth region 316-4.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at an electronic device in communication with one or more displays, one or more input devices, and one or more cameras: capturing, via the one or more cameras, one or more images of a physical environment, including a first object; in accordance with detecting, in the one or more images, a first region of the first object and that one or more first criteria are satisfied, displaying, via the one or more displays, a first user interface element including first suggested text in a computer-generated environment, wherein the first user interface element is displayed at a first location based on the first region; and in accordance with detecting, in the one or more images, a second region, different from the first region, of the first object and that one or more second criteria are satisfied, displaying, via the one or more displays, a second user interface element including second suggested text in the computer-generated environment, wherein the second user interface element is displayed at a second location, different from the first location, based on the second region.

Additionally or alternatively, in some examples, the first object corresponds to a physical document. Additionally or alternatively, in some examples, the first object corresponds to a physical display that is displaying a user interface. Additionally or alternatively, in some examples, the first object corresponds to a locking device. Additionally or alternatively, in some examples, the first region corresponds to a first fillable field, and the second region corresponds to a second fillable field, different from the first fillable field. Additionally or alternatively, in some examples, the one or more first criteria include a criterion that is satisfied when gaze of the user is directed toward the first region when detecting, in the one or more images, the first region of the first object, and the one or more second criteria include a criterion that is satisfied when the gaze of the user is directed toward the second region when detecting, in the one or more images, the second region of the first object. Additionally or alternatively, in some examples, the one or more first criteria include a criterion that is satisfied when a respective object associated with the user is detected within a threshold distance of the first region when detecting, in the one or more images, the first region of the first object, and the one or more second criteria include a criterion that is satisfied when the respective object associated with the user is detected within the threshold distance of the second region when detecting, in the one or more images, the second region of the first object. Additionally or alternatively, in some examples, the one or more first criteria include a criterion that is satisfied when the first suggested text is associated with a threshold confidence level based on one or more characteristics of the first region, and the one or more second criteria include a criterion that is satisfied when the second suggested text is associated with the threshold confidence level based on one or more characteristics of the second region.

Additionally or alternatively, in some examples, the one or more first criteria include a criterion that is satisfied when first content included in the first region is applicable to the user, and the one or more second criteria include a criterion that is satisfied when second content included in the second region is applicable to the user. Additionally or alternatively, in some examples, the one or more first criteria include a criterion that is satisfied when the first object remains in a field of view of the electronic device for at least a threshold amount of time when detecting, in the one or more images, the first region of the first object, and the one or more second criteria include a criterion that is satisfied when the second object remains in the field of view for at least the threshold amount of time when detecting, in the one or more images, the second region of the first object. Additionally or alternatively, in some examples, the first suggested text is displayed based on one or more features of the first region, and the second suggested text is displayed based on one or more features of the second region. Additionally or alternatively, in some examples, the one or more features of the first region include first text that is included in the first region, and the one or more features of the second region include second text that is included in the second region. Additionally or alternatively, in some examples, the one or more features of the first region and the one or more features of the second region include a type of the first object. Additionally or alternatively, in some examples, the first suggested text is displayed based on first user data that is accessible on the electronic device, and the second suggested text is displayed based on second user data that is accessible on the electronic device. Additionally or alternatively, in some examples, the first user data and the second user data are stored in memory of the electronic device. Additionally or alternatively, in some examples, the first user data and the second user data are provided by one or more applications running on the electronic device. Additionally or alternatively, in some examples, the first user data and the second user data are accessible based on a current location of the electronic device.

Additionally or alternatively, in some examples, displaying the first user interface element includes, in accordance with a determination that the first suggested text includes a plurality of first options, displaying the plurality of first options as a first list in the first user interface element, and displaying the second user interface element includes, in accordance with a determination that the second suggested text includes a plurality of second options, displaying the plurality of second options as a second list in the second user interface element. Additionally or alternatively, in some examples, the first location is outside a boundary of the first region, and the second location is outside a boundary of the second region. Additionally or alternatively, in some examples, the first location is at least a threshold distance from the first region, and the second location is at least the threshold distance from the second region. Additionally or alternatively, in some examples, the method further comprises, in accordance with detecting, in the one or more images, a third region, different from the first region and the second region, of the first object and that one or more third criteria are satisfied, displaying, via the one or more displays, a third user interface element including third suggested text in the computer-generated environment, wherein the third user interface element is displayed at a third location, different from the first location and the second location, based on the third region. Additionally or alternatively, in some examples, the method further comprises, in accordance with a determination that the one or more first criteria and the one or more second criteria are satisfied, concurrently displaying, via the one or more displays, the first user interface element at the first location and the second user interface element at the second location in the computer-generated environment. Additionally or alternatively, in some examples, the method further comprises:
after displaying the first user interface element at the first location in the computer-generated environment, detecting, in the first region of the first object, first text, wherein the first text was not detected prior to displaying the first user interface element; and in accordance with detecting, in the one or more images, a third region of the first object and that one or more third criteria are satisfied, displaying, via the one or more displays, a third user interface element including third suggested text in the computer-generated environment, wherein the third user interface element is displayed at a third location based on the first region and the third suggested text is based on the first text.

Additionally or alternatively, in some examples, the method further comprises: while displaying the first user interface element at the first location in the computer-generated environment, detecting, in the first region of the first object, first text, wherein the first text was not detected prior to displaying the first user interface element; and in response to detecting the first text in the first region of the first object, ceasing display of the first user interface element in the computer-generated environment. Additionally or alternatively, in some examples, the method further comprises: after displaying the first user interface element at the first location in the computer-generated environment, detecting, in the first region of the first object, first text, wherein the first text was not detected prior to displaying the first user interface element; and in response to detecting the first text, in accordance with a determination that at least a portion of the first text is different from a corresponding portion of the first suggested text, displaying, via the one or more displays, a visual indication in the computer-generated environment. Additionally or alternatively, in some examples, the visual indication is displayed with the at least the portion of the first text. Additionally or alternatively, in some examples, the visual indication is displayed a threshold amount of time after detecting the first text in the first region. Additionally or alternatively, in some examples, the method further comprises: in accordance with detecting, in the one or more images, the first region of the first object and that the one or more first criteria are not satisfied, forgoing displaying, via the one or more displays, the first user interface element including the first suggested text in the computer-generated environment; and in accordance with detecting, in the one or more images, the second region of the first object and that the one or more second criteria are not satisfied, forgoing displaying the second user interface element including the second suggested text in the computer-generated environment.

Additionally or alternatively, in some examples, the one or more first criteria include a criterion that is satisfied when a respective object associated with the user is detected as being directed toward the first region for at least a threshold amount of time when detecting, in the one or more images, the first region of the first object, and the one or more second criteria include a criterion that is satisfied when the respective object associated with the user is detected as being directed toward the second region for at least the threshold amount of time when detecting, in the one or more images, the second region of the first object. Additionally or alternatively, in some examples, the method further comprises, in accordance with detecting the respective object associated with the user directed toward the first region or the second region of the first object, displaying, via the one or more displays, a visual indication of an elapsing of the threshold amount of time in the computer-generated environment. Additionally or alternatively, in some examples, the method further comprises: while displaying the visual indication of the elapsing of the threshold amount of time in the computer-generated environment, capturing, via the one or more cameras, one or more second images of the physical environment; detecting, in the one or more second images, the respective object associated with the user is no longer directed toward the first region or the second region of the first object; and in response to detecting the respective object associated with the user is no longer directed toward the first region or the second region, in accordance with a determination that the threshold amount of time has not elapsed prior to detecting the respective object associated with the user directed toward the first region or the second region, ceasing display of the visual indication in the computer-generated environment, and forgoing display of the first user interface element or the second user interface element in the computer-generated environment.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data may be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more displays, one or more input devices, and one or more cameras:
capturing, via the one or more cameras, one or more images of a physical environment, including a first object;
in accordance with detecting, in the one or more images, a first region of the first object and that one or more first criteria are satisfied, displaying, via the one or more displays, a first user interface element including first suggested text in a computer-generated environment, wherein the first user interface element is displayed at a first location based on the first region; and
in accordance with detecting, in the one or more images, a second region, different from the first region, of the first object and that one or more second criteria are satisfied, displaying, via the one or more displays, a second user interface element including second suggested text in the computer-generated environment, wherein the second user interface element is displayed at a second location, different from the first location, based on the second region.

2. The method of claim 1, wherein:
the first region corresponds to a first fillable field; and
the second region corresponds to a second fillable field, different from the first fillable field.

3. The method of claim 1, wherein:
the one or more first criteria include a criterion that is satisfied when gaze of a user of the electronic device is directed toward the first region when detecting, in the one or more images, the first region of the first object; and
the one or more second criteria include a criterion that is satisfied when the gaze of the user is directed toward the second region when detecting, in the one or more images, the second region of the first object.

4. The method of claim 1, wherein:
the one or more first criteria include a criterion that is satisfied when a respective object associated with a user of the electronic device is detected within a threshold distance of the first region when detecting, in the one or more images, the first region of the first object; and
the one or more second criteria include a criterion that is satisfied when the respective object associated with the user is detected within the threshold distance of the second region when detecting, in the one or more images, the second region of the first object.

5. The method of claim 1, wherein:
the one or more first criteria include a criterion that is satisfied when a respective object associated with a user of the electronic device is detected as being directed toward the first region for at least a threshold amount of time when detecting, in the one or more images, the first region of the first object; and
the one or more second criteria include a criterion that is satisfied when the respective object associated with the user is detected as being directed toward the second region for at least the threshold amount of time when detecting, in the one or more images, the second region of the first object.

6. The method of claim 1, wherein:
the first suggested text is displayed based on one or more features of the first region, including first text that is included in the first region; and
the second suggested text is displayed based on one or more features of the second region, including second text that is included in the second region.

7. The method of claim 1, further comprising:
while displaying the first user interface element at the first location in the computer-generated environment, detecting, in the first region of the first object, first text, wherein the first text was not detected prior to displaying the first user interface element; and
in response to detecting the first text in the first region of the first object, ceasing display of the first user interface element in the computer-generated environment.

8. The method of claim 1, further comprising:
after displaying the first user interface element at the first location in the computer-generated environment, detecting, in the first region of the first object, first text, wherein the first text was not detected prior to displaying the first user interface element; and
in response to detecting the first text:
in accordance with a determination that at least a portion of the first text is different from a corresponding portion of the first suggested text, displaying, via the one or more displays, a visual indication in the computer-generated environment.

9. An electronic device comprising:
one or more processors;
memory; and
one or more programs stored in the memory and configured to be executed by the one or more processors, the one or more programs including instructions for performing a method comprising:
capturing, via one or more cameras, one or more images of a physical environment, including a first object;
in accordance with detecting, in the one or more images, a first region of the first object and that one or more first criteria are satisfied, displaying, via one or more displays, a first user interface element including first suggested text in a computer-generated environment, wherein the first user interface element is displayed at a first location based on the first region; and
in accordance with detecting, in the one or more images, a second region, different from the first region, of the first object and that one or more second criteria are satisfied, displaying, via the one or more displays, a second user interface element including second suggested text in the computer-generated environment, wherein the second user interface element is displayed at a second location, different from the first location, based on the second region.

10. The electronic device of claim 9, wherein:
the first region corresponds to a first fillable field; and
the second region corresponds to a second fillable field, different from the first fillable field.

11. The electronic device of claim 9, wherein:
the one or more first criteria include a criterion that is satisfied when gaze of a user of the electronic device is directed toward the first region when detecting, in the one or more images, the first region of the first object; and
the one or more second criteria include a criterion that is satisfied when the gaze of the user is directed toward the second region when detecting, in the one or more images, the second region of the first object.

12. The electronic device of claim 9, wherein:
the one or more first criteria include a criterion that is satisfied when a respective object associated with a user of the electronic device is detected within a threshold distance of the first region when detecting, in the one or more images, the first region of the first object; and
the one or more second criteria include a criterion that is satisfied when the respective object associated with the user is detected within the threshold distance of the second region when detecting, in the one or more images, the second region of the first object.

13. The electronic device of claim 9, wherein:
the one or more first criteria include a criterion that is satisfied when a respective object associated with a user of the electronic device is detected as being directed toward the first region for at least a threshold amount of time when detecting, in the one or more images, the first region of the first object; and
the one or more second criteria include a criterion that is satisfied when the respective object associated with the user is detected as being directed toward the second region for at least the threshold amount of time when detecting, in the one or more images, the second region of the first object.

14. The electronic device of claim 9, wherein:
the first suggested text is displayed based on one or more features of the first region, including first text that is included in the first region; and
the second suggested text is displayed based on one or more features of the second region, including second text that is included in the second region.

15. The electronic device of claim 9, wherein the method further comprises:
while displaying the first user interface element at the first location in the computer-generated environment, detecting, in the first region of the first object, first text, wherein the first text was not detected prior to displaying the first user interface element; and
in response to detecting the first text in the first region of the first object, ceasing display of the first user interface element in the computer-generated environment.

16. The electronic device of claim 9, wherein the method further comprises:
after displaying the first user interface element at the first location in the computer-generated environment, detecting, in the first region of the first object, first text, wherein the first text was not detected prior to displaying the first user interface element; and
in response to detecting the first text:
in accordance with a determination that at least a portion of the first text is different from a corresponding portion of the first suggested text, displaying, via the one or more displays, a visual indication in the computer-generated environment.

17. A non-transitory computer readable storage medium storing one or more programs, the one or more programs comprising instructions, which when executed by one or more processors of an electronic device, cause the electronic device to perform a method comprising:
capturing, via one or more cameras, one or more images of a physical environment, including a first object;
in accordance with detecting, in the one or more images, a first region of the first object and that one or more first criteria are satisfied, displaying, via one or more displays, a first user interface element including first suggested text in a computer-generated environment, wherein the first user interface element is displayed at a first location based on the first region; and
in accordance with detecting, in the one or more images, a second region, different from the first region, of the first object and that one or more second criteria are satisfied, displaying, via the one or more displays, a second user interface element including second suggested text in the computer-generated environment, wherein the second user interface element is displayed at a second location, different from the first location, based on the second region.

18. The non-transitory computer readable storage medium of claim 17, wherein:
the first region corresponds to a first fillable field; and
the second region corresponds to a second fillable field, different from the first fillable field.

19. The non-transitory computer readable storage medium of claim 17, wherein:
the one or more first criteria include a criterion that is satisfied when gaze of a user of the electronic device is directed toward the first region when detecting, in the one or more images, the first region of the first object; and
the one or more second criteria include a criterion that is satisfied when the gaze of the user is directed toward the second region when detecting, in the one or more images, the second region of the first object.

20. The non-transitory computer readable storage medium of claim 17, wherein:
the one or more first criteria include a criterion that is satisfied when a respective object associated with a user of the electronic device is detected within a threshold distance of the first region when detecting, in the one or more images, the first region of the first object; and
the one or more second criteria include a criterion that is satisfied when the respective object associated with the user is detected within the threshold distance of the second region when detecting, in the one or more images, the second region of the first object.

21. The non-transitory computer readable storage medium of claim 17, wherein:
the one or more first criteria include a criterion that is satisfied when a respective object associated with a user of the electronic device is detected as being directed toward the first region for at least a threshold amount of time when detecting, in the one or more images, the first region of the first object; and
the one or more second criteria include a criterion that is satisfied when the respective object associated with the user is detected as being directed toward the second region for at least the threshold amount of time when detecting, in the one or more images, the second region of the first object.

22. The non-transitory computer readable storage medium of claim 17, wherein:
the first suggested text is displayed based on one or more features of the first region, including first text that is included in the first region; and
the second suggested text is displayed based on one or more features of the second region, including second text that is included in the second region.

23. The non-transitory computer readable storage medium of claim 17, wherein the method further comprises:
while displaying the first user interface element at the first location in the computer-generated environment, detecting, in the first region of the first object, first text, wherein the first text was not detected prior to displaying the first user interface element; and
in response to detecting the first text in the first region of the first object, ceasing display of the first user interface element in the computer-generated environment.

24. The non-transitory computer readable storage medium of claim 17, wherein the method further comprises:
after displaying the first user interface element at the first location in the computer-generated environment, detecting, in the first region of the first object, first text, wherein the first text was not detected prior to displaying the first user interface element; and
in response to detecting the first text:
in accordance with a determination that at least a portion of the first text is different from a corresponding portion of the first suggested text, displaying, via the one or more displays, a visual indication in the computer-generated environment.
